(19) United States
(12) Patent Application Publication
(10) Pub. No.: US 2017/0076207 A1
(43) Pub. Date: Mar. 16, 2017

(54) Interactive Interface for Model Selection

(71) Applicants: Michael Ryan Chipley, Raleigh, NC (US); Michael J. Leonard, Cary, NC (US); Philip Lodge Holman, Raleigh, NC (US); Jerzy Michael Brzezicki, Cary, NC (US); Karl Moss, Raleigh, NC (US); Dinesh P. Apte, Pune (IN)

(72) Inventors: Michael Ryan Chipley, Raleigh, NC (US); Michael J. Leonard, Cary, NC (US); Philip Lodge Holman, Raleigh, NC (US); Jerzy Michael Brzezicki, Cary, NC (US); Karl Moss, Raleigh, NC (US); Dinesh P. Apte, Pune (IN)

(21) Appl. No.: 15/137,977

(22) Filed: Apr. 25, 2016

Related U.S. Application Data
(63) Continuation-in-part of application No. 13/772,200, filed on Feb. 20, 2013, now abandoned.
Application No. 13/772,200 is a continuation of application No. 12/611,497, filed on Nov. 3, 2009, now abandoned.

(51) Int. Cl. G06N 5/02; G06F 3/0482; G06F 3/0481; G06F 3/0484

(52) U.S. Cl. CPC G06N 5/022; G06F 3/04842; G06F 3/0482; G06F 3/04817

(57) ABSTRACT

Systems, products, and methods are disclosed for improving the accuracy of predictions.

Possible values of an output variable can be generated based on past values and possible values of input variables and a model. Multiple scenarios can be run, each of which may vary in many factors, such as the model used and the input variables used. Results from multiple scenarios can be presented to a user. Prediction accuracy can be improved through selection of one or more desirable scenarios.

### CROSS REFERENCE TO RELATED APPLICATIONS

This application is a continuation-in-part application of U.S. patent application Ser. No. 13/772,200 filed Feb. 20, 2013, entitled “Computer-Implemented Systems and Methods for Scenario Analysis,” which is a continuation application of U.S. patent application Ser. No. 12/611,497 filed Nov. 3, 2009, entitled “Computer-Implemented Systems and Methods for Scenario Analysis.”

### TECHNICAL FIELD

The technology described herein relates generally to computer systems and more specifically to computer systems for intelligently improving scenario selection.

### BACKGROUND

In various fields, generation of accurate possible values for certain variables can be very important to operations. Generated possible values can relate to the effect a given future event may have or to what events must occur based on goal conditions. Additionally, the relationship between contributing factors and desired objectives can be found. Thus, beneficial changes to the objectives can be designed using knowledge of that relationship. However, it can be especially difficult to ascertain the best model for producing accurate predictions.

### SUMMARY

Certain aspects and features of the present disclosure relate to a system, comprising one or more data processors; and a non-transitory computer-readable storage medium containing instructions which, when executed on the one or more data processors, cause the one or more data processors to perform operations including: storing a plurality of models, each model being associated with an input variable and an output variable and each model operable to estimate possible values for the output variable associated with that model; storing scenario information, wherein storing scenario information includes associating each of a plurality of scenarios with two or more of the plurality of models; displaying scenario selection information on a graphical interface by individually depicting each of the plurality of scenarios, wherein individually depicting a scenario includes depicting the models that are associated with that scenario, and wherein depicting a model includes indicating the input variable and the output variable associated with that model; receiving a scenario selection input indicating a selected one of the plurality of scenarios; receiving a model selection input indicating a selected one of the plurality of models associated with the selected scenario; receiving input variable information; generating possible values of the input variable associated with the selected model using the input variable information; and generating a collection of values of the output variable associated with the selected model using the selected model and the possible input values.

Certain aspects and features of the present disclosure relate to a computer-implemented method comprising: storing a plurality of models, each model being associated with an input variable and an output variable and each model operable to estimate possible values for the output variable associated with that model; storing scenario information, wherein storing scenario information includes associating each of a plurality of scenarios with two or more of the plurality of models; displaying scenario selection information on a graphical interface by individually depicting each of the plurality of scenarios, wherein individually depicting a scenario includes depicting the models that are associated with that scenario, and wherein depicting a model includes indicating the input variable and the output variable associated with that model; receiving a scenario selection input indicating a selected one of the plurality of scenarios; receiving a model selection input indicating a selected one of the plurality of models associated with the selected scenario; receiving input variable information; generating possible values of the input variable associated with the selected model using the input variable information; and generating a collection of values of the output variable associated with the selected model using the selected model and the possible input values.

Certain aspects and features of the present disclosure relate to a computer-program product tangibly embodied in a non-transitory machine-readable storage medium, including instructions configured to cause a data processing apparatus to perform operations including: storing a plurality of models, each model being associated with an input variable and an output variable and each model operable to estimate possible values for the output variable associated with that model; storing scenario information, wherein storing scenario information includes associating each of a plurality of scenarios with two or more of the plurality of models; displaying scenario selection information on a graphical interface by individually depicting each of the plurality of scenarios, wherein individually depicting a scenario includes depicting the models that are associated with that scenario, and wherein depicting a model includes indicating the input variable and the output variable associated with that model; receiving a scenario selection input indicating a selected one of the plurality of scenarios; receiving a model selection input indicating a selected one of the plurality of models associated with the selected scenario; receiving input variable information; and generating possible values of the input variable associated with the selected model using the input variable information; and generating a collection of values of the output variable associated with the selected model using the selected model and the possible input values.

In some cases, the input variable information includes a rate, and generating the possible values uses the rate. In some cases, each of the models is further operable to perform goal-seeking, wherein goal-seeking includes calculating values for the input variable associated with the selected model, and wherein calculating is based on assumed values of the output variable associated with the selected model. In some cases, the method or the operations further include: receiving goal-seeking information indicating assumed values of the output variable associated with the selected model; and performing a goal-seeking calculation based on the selected model and the assumed values of the output variable associated with the selected model, wherein performing the goal-seeking calculation includes determining values of the input variable associated with the selected model. In some cases, the selected model includes a mathematical relationship between the input variable associated with the selected model and the output variable associated with the selected model. In some cases, determining values of the input variable associated with the model includes using the mathematical relationship. In some cases, the scenario information includes, for at least one of the plurality of scenarios, a name, a date, or a description. In some cases, the method or operations further include, for each of the depicted scenarios, storing a name and type of the input variable associated with the scenario. In some cases, the method or operations further include: storing multiple input variable manipulation options; receiving selection information indicating a selection of one of the multiple input variable manipulation options; altering the possible values of the input variable associated with the selected model, wherein altering is performed based on the selected one of the multiple input variable manipulation options; and generating updated possible values of the output variable associated with the selected model, wherein generating updated possible values includes using the selected model and the altered possible values of the input variable. In some cases, the method or operations further include displaying a model selection interface, wherein displaying a model selection interface includes displaying, with respect to each of the models, a quality metric representative of that model's performance when evaluated with holdout data. In some cases, displaying a model selection interface further includes displaying, with respect to each of the models, information about the input variable and output variable with which the model is associated. In some cases, each of the multiple models is associated with multiple input variables. In some cases, displaying a model selection interface further includes displaying, with respect to each of the models, a variable sensitivity indication corresponding to that model, wherein a variable sensitivity indication corresponding to a model depicts input variables with which that model is both associated with and sensitive to.

Certain aspects of the present disclosure relate to a system comprising one or more data processors and a non-transitory computer-readable storage medium containing instructions which, when executed on the one or more data processors, cause the one or more data processors to perform operations including: storing a plurality of models, each model being associated with an input variable and an output variable and each model operable to estimate possible values for the output variable associated with that model; storing scenario information, wherein storing scenario information includes associating each of a plurality of scenarios with two or more of the plurality of models; displaying scenario selection information on a graphical interface by individually depicting each of the plurality of scenarios, wherein individually depicting a scenario includes depicting the models that are associated with that scenario, and wherein depicting a model includes indicating the input variable and the output variable associated with that model; receiving a scenario selection input indicating a selected one of the plurality of scenarios; receiving a model selection input indicating a selected one of the plurality of models associated with the selected scenario; receiving input variable information;

generating possible values of the input variable associated with the selected model using the input variable information; and generating a collection of values of the output variable associated with the selected model using the selected model and the possible input values.

Certain aspects of the present disclosure relate to a computer-implemented method comprising storing a plurality of models, each model being associated with an input variable and an output variable and each model operable to estimate possible values for the output variable associated with that model; storing scenario information, wherein storing scenario information includes associating each of a plurality of scenarios with two or more of the plurality of models; displaying scenario selection information on a graphical interface by individually depicting each of the plurality of scenarios, wherein individually depicting a scenario includes depicting the models that are associated with that scenario, and wherein depicting a model includes indicating the input variable and the output variable associated with that model; receiving a scenario selection input indicating a selected one of the plurality of scenarios; receiving a model selection input indicating a selected one of the plurality of models associated with the selected scenario; receiving input variable information; generating possible values of the input variable associated with the selected model using the input variable information; and generating a collection of values of the output variable associated with the selected model using the selected model and the possible input values.

Certain aspects of the present disclosure relate to a computer-program product tangibly embodied in a non-transitory machine-readable storage medium, including instructions configured to cause a data processing apparatus to perform operations including: storing a plurality of models, each model being associated with an input variable and an output variable and each model operable to estimate possible values for the output variable associated with that model; storing scenario information, wherein storing scenario information includes associating each of a plurality of scenarios with two or more of the plurality of models; displaying scenario selection information on a graphical interface by individually depicting each of the plurality of scenarios, wherein individually depicting a scenario includes depicting the models that are associated with that scenario, and wherein depicting a model includes indicating the input variable and the output variable associated with that model; receiving a scenario selection input indicating a selected one of the plurality of scenarios; receiving a model selection input indicating a selected one of the plurality of models associated with the selected scenario; receiving input variable information; generating possible values of the input variable associated with the selected model using the input variable information; and generating a collection of values of the output variable associated with the selected model using the selected model and the possible input values.

Certain aspects of the present disclosure relate to systems, methods, and computer-program products wherein the input variable information includes a rate, and wherein generating the possible values uses the rate.

Certain aspects of the present disclosure relate to systems, methods, and computer-program products wherein each of the models is further operable to perform goal-seeking, wherein goal-seeking includes calculating values for the input variable associated with the selected model, and wherein calculating is based on assumed values of the output variable associated with the selected model. Certain aspects of the present disclosure relate to systems, methods, and computer-program products further including receiving goal-seeking information indicating assumed values of the output variable associated with the selected model; and performing a goal-seeking calculation based on the selected model and the assumed values of the output variable associated with the selected model, wherein performing the goal-seeking calculation includes determining values of the input variable associated with the selected model. Certain aspects of the present disclosure relate to systems, methods, and computer-program products wherein the selected model includes a mathematical relationship between the input variable associated with the selected model and the output variable associated with the selected model. Certain aspects of the present disclosure relate to systems, methods, and computer-program products wherein determining values of the input variable associated with the model includes using the mathematical relationship.

Certain aspects of the present disclosure relate to systems, methods, and computer-program products wherein the scenario information includes, for at least one of the plurality of scenarios, a name, a date, or a description. Certain aspects of the present disclosure relate to systems, methods, and computer-program products wherein the operations further include, for each of the depicted scenarios, storing a name and type of the input variable associated with the scenario. Certain aspects of the present disclosure relate to systems, methods, and computer-program products further including storing multiple input variable manipulation options; receiving selection information indicating a selection of one of the multiple input variable manipulation options; altering the possible values of the input variable associated with the selected model, wherein altering is performed based on the selected one of the multiple input variable manipulation options; and generating updated possible values of the output variable associated with the selected model, wherein generating updated possible values includes using the selected model and the altered possible values of the input variable.

Certain aspects of the present disclosure relate to systems, methods, and computer-program products further including displaying a model selection interface, wherein displaying a model selection interface includes displaying, with respect to each of the models, a quality metric representative of that model's performance when evaluated with holdout data. Certain aspects of the present disclosure relate to systems, methods, and computer-program products wherein displaying a model selection interface further includes displaying, with respect to each of the models, information about the input variable and output variable with which the model is associated. In some cases, each of the multiple models is associated with multiple input variables. In some cases, displaying a model selection interface further includes displaying, with respect to each of the models, a variable sensitivity indication corresponding to that model, wherein a variable sensitivity indication corresponding to a model depicts input variables with which that model is both associated with and sensitive to.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

The present disclosure is described in conjunction with the appended figures:

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates a portion of a communications grid computing system including a control node and a worker node, according to some embodiments of the present technology.

FIG. 7 illustrates a flow chart showing an example process for executing a data analysis or processing project, according to some embodiments of the present technology.

FIG. 8 illustrates a block diagram including components of an Event Stream Processing Engine (ESPE), according to embodiments of the present technology.

FIG. 9 illustrates a flow chart showing an example process including operations performed by an event stream processing engine, according to some embodiments of the present technology.

FIG. 10 illustrates an ESP system interfacing between a publishing device and multiple event subscribing devices, according to embodiments of the present technology.

FIG. 11 depicts a computer-implemented environment wherein users can interact with a scenario analysis handler hosted on one or more servers through a network.

FIG. 12 is a block diagram depicting an example project handled by a scenario analysis handler.

FIG. 13 is a block diagram depicting relationships among scenarios, models, and input variables which are managed by a scenario analysis handler.

FIG. 14 is a block diagram depicting data records managed by a scenario analysis handler.

FIG. 15 is a block diagram depicting example data structures managed by a scenario analysis handler.

FIG. 16 is a screenshot depicting a graphical user interface for providing input data defining a new scenario for incorporation into a project.

FIG. 17 is a screenshot depicting a graphical user interface for providing expanded details of models available for selection in a scenario.

FIG. 18 is a screenshot depicting a graphical user interface for identifying desired manipulations for a variable in a scenario.

FIG. 19 is a screenshot depicting a graphical user interface for providing details of models associated with a project.

FIGS. 20A and 20B are data tables depicting example data associated with a plurality of scenarios within a project.

FIG. 21 is a screenshot depicting a graphical user interface for editing a model associated with a scenario.

FIGS. 22A and 22B are screenshots depicting a graphical user interface for displaying determinations of possible values for one or more scenarios.

FIG. 23 is a screenshot depicting a graphical user interface for displaying a comparison of possible values associated with multiple scenarios simultaneously.

FIGS. 24A and 24B are screenshots depicting a graphical user interface for displaying one or more scenarios in comparison with a prior forecast.

FIG. 25 is a flow diagram depicting a computer-implemented method of implementing a scenario analysis handler that performs multiple scenarios based upon time series data that is representative of transactional data and displays results of the multiple scenarios simultaneously.

FIG. 26 depicts an example system that includes a stand alone computer architecture where a processing system includes a scenario analysis handler being executed on it.

FIG. 27 depicts a system that includes a client server architecture.

FIG. 28 shows a block diagram of exemplary hardware for a standalone computer architecture, such as the architecture depicted in FIG. 26, that may be used to contain and/or implement the program instructions of system embodiments of the present disclosure.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional operations not included in a figure. A process may correspond to a method, a function, a procedure, a subroutine, a subprogram, etc. When a process corresponds to a function, its termination can correspond to a return of the function to the calling function or the main function.

Systems depicted in some of the figures may be provided in various configurations. In some embodiments, the systems may be configured as a distributed system where one or more components of the system are distributed across one or more networks in a cloud computing system.

Certain aspects of the present disclosure relate to systems, products, and methods for improving the accuracy of predictions. Improving the accuracy can include selecting an optimal or desired model from a set of models. Improving the accuracy can also include generating values for output variables based on both received input variables and estimated input variables. Possible values of an output variable can be generated based on past and hypothetical values of input variables. As used herein, a possible value can refer to a future value. A scenario analysis handler can enable multiple scenarios to be generated and simultaneously compared, each of which may vary in many factors, such as the model used and the input variables used. Results from multiple scenarios can be presented to a user. Prediction accuracy can be improved through selection of one or more desirable scenarios.

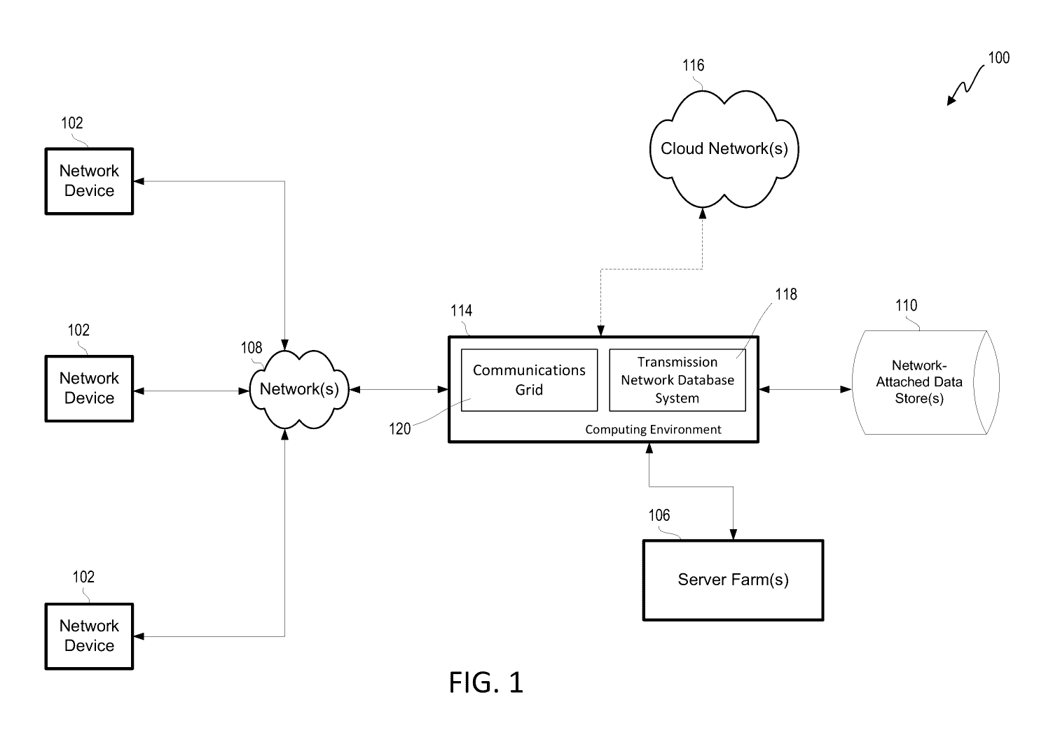

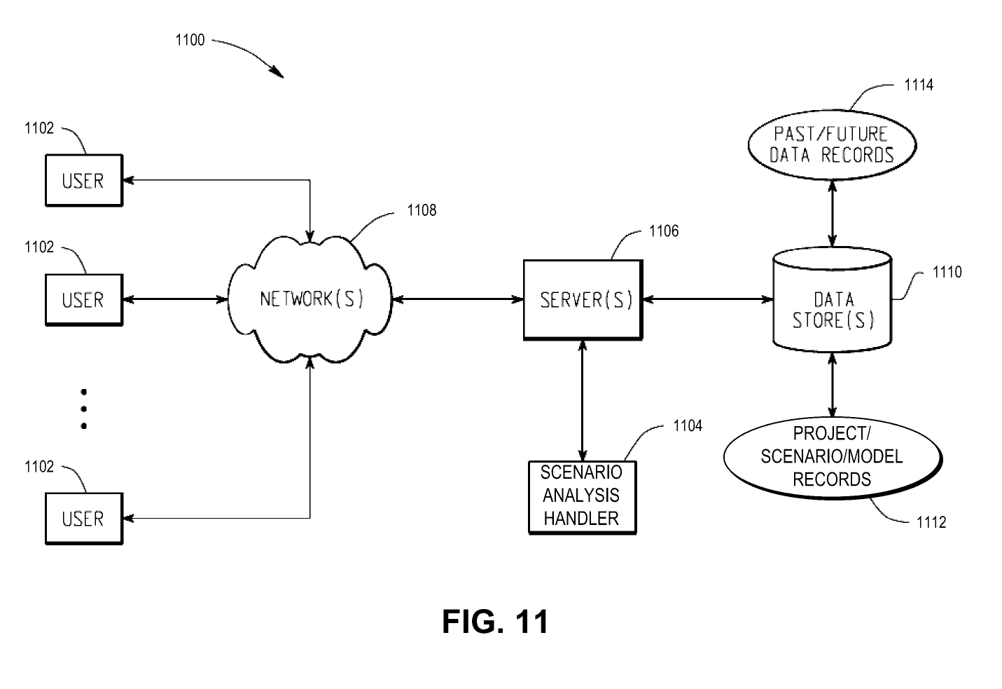

FIG. 1 is a block diagram that provides an illustration of the hardware components of a data transmission network 100, according to embodiments of the present technology. Data transmission network 100 is a specialized computer system that may be used for processing large amounts of data where a large number of computer processing cycles are required. Data transmission network 100 can be used with the various aspects of the disclosure, such as those disclosed in FIGS. 11-28, such as for storing, displaying, receiving, generating, or performing other tasks related to models, scenario information, and variables as disclosed herein.

Data transmission network 100 may also include computing environment 114. Computing environment 114 may be a specialized computer or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

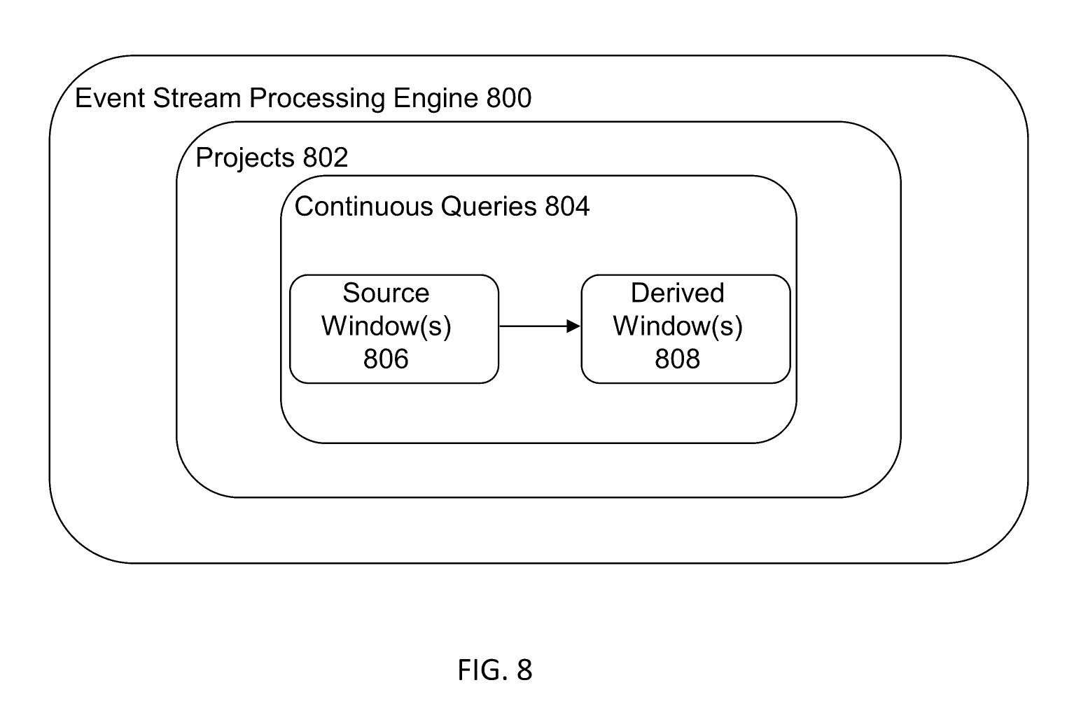

In other embodiments, network devices may provide a large amount of data, either all at once or streaming over a period of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other computer networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices, and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying products being manufactured with parameter data for each product, such as colors and models) or product sales databases (e.g., a database containing individual data records identifying details of individual product sales).

The unstructured data may be presented to the computing environment 114 in different forms such as a flat file or a conglomerate of data records, and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time period units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more sever farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may comprise one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, on demand, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

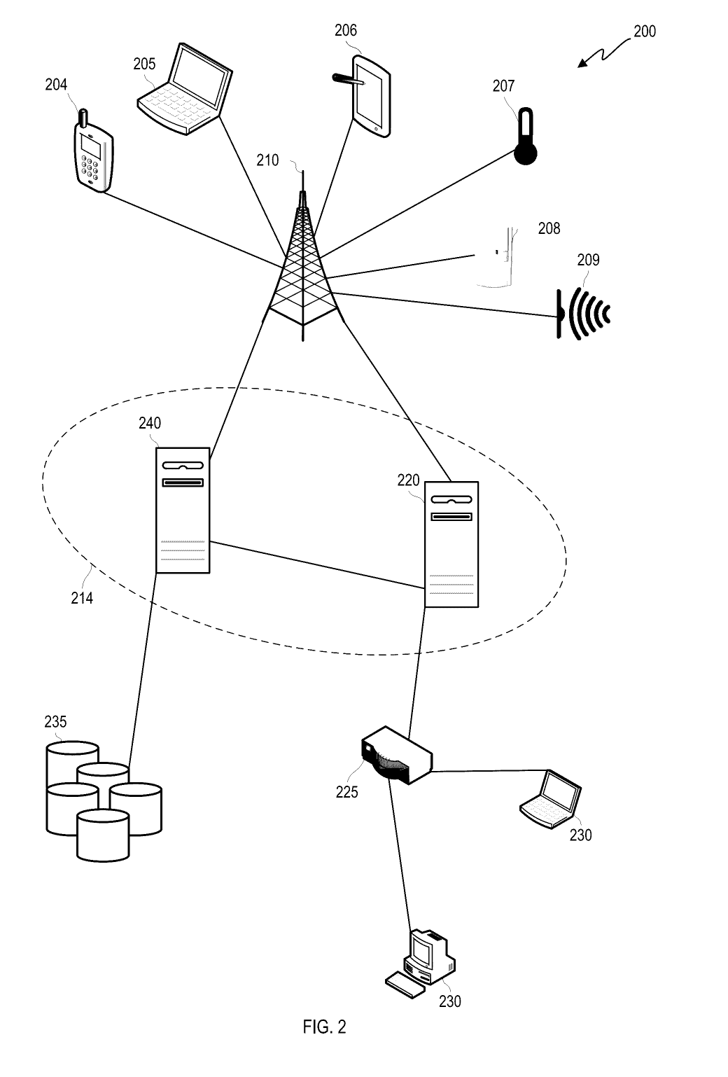

Each communication within data transmission network 100 (e.g., between client devices, between a device and connection management system 150, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a Bluetooth or a Bluetooth Low Energy channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IoT), where things (e.g., machines, devices, phones, sensors) can be connected to networks and the data from these things can be collected and processed within the things and/or external to the things. For example, the IoT can include sensors in many different devices, and high value analytics can be applied to identify hidden relationships and drive increased efficiencies. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, electrical current, among others. The sensors may be mounted to various components used as part of a variety of different types of systems (e.g., an oil drilling operation). The network devices may detect and record data related to the environment that it monitors, and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-playback devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, homes and businesses of consumers, among others. One or more of such devices may include one or more sensors that detect energy gain or loss, electrical input or output or loss, and a variety of other efficiencies. These sensors may collect data to inform users of how the energy grid, and individual devices within the grid, may be functioning and how they may be made more efficient.

Network device sensors may also perform processing on data it collects before transmitting the data to the computing environment 114, or before deciding whether to transmit data to the computing environment 114. For example, network devices may determine whether data collected meets certain rules, for example by comparing data or values calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operations, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 240, computing environment 214 may include a web server 240. Thus, computing environment 214 can retrieve data of interest, such as client information (e.g., product information, client rules, etc.), technical product details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over a period of time for a client to determine results data based on the client's needs and rules.

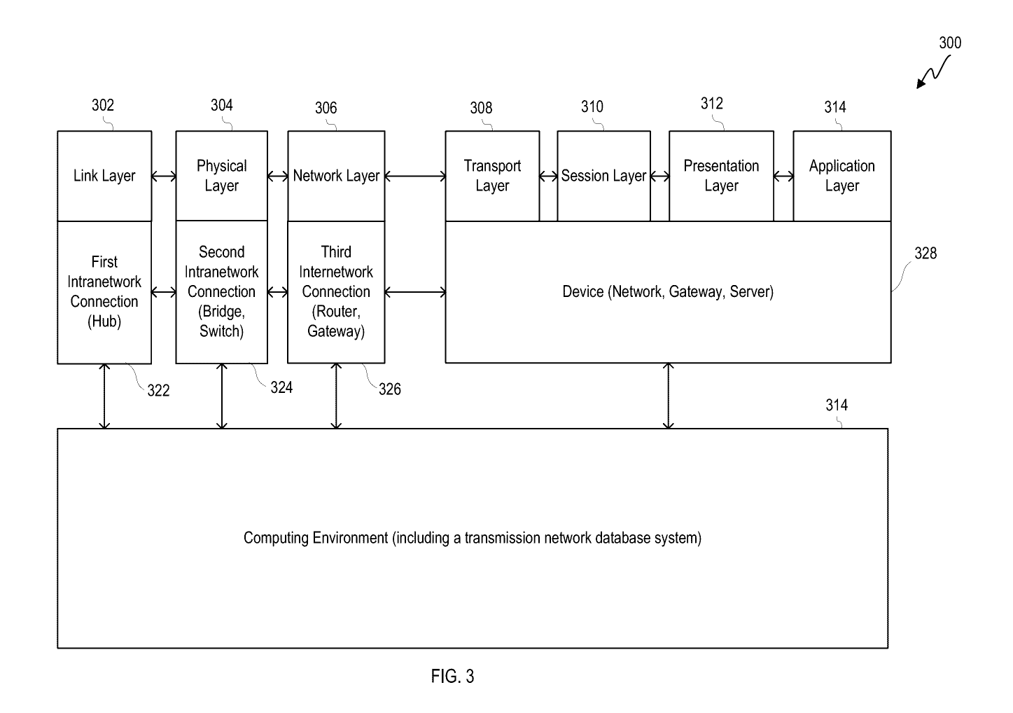

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 302-314. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data, and is the farthest layer from the user in a communications system. On the other hand, the application layer is the highest layer because it interacts directly with a software application.

As noted, the model includes a physical layer 302. Physical layer 302 represents physical communication, and can define parameters of that physical communication. For example, such physical communication may come in the form of electrical, optical, or electromagnetic signals. Physical layer 302 also defines protocols that may control communications within a data transmission network.

Link layer 304 defines links and mechanisms used to transmit (i.e., move) data across a network. The link layer manages node-to-node communications, such as within a grid computing environment. Link layer 304 can detect and correct errors (e.g., transmission errors in the physical layer 302). Link layer 304 can also include a media access control (MAC) layer and logical link control (LLC) layer.

Network layer 306 defines the protocol for routing within a network. In other words, the network layer coordinates transferring data across nodes in a same network (e.g., such as a grid computing environment). Network layer 306 can also define the processes used to structure local addressing within the network.

Transport layer 308 can manage the transmission of data and the quality of the transmission and/or receipt of that data. Transport layer 308 can provide a protocol for transferring data, such as, for example, a Transmission Control Protocol (TCP). Transport layer 308 can assemble and disassemble data frames for transmission. The transport layer can also detect transmission errors occurring in the layers below it.

Session layer 310 can establish, maintain, and manage communication connections between devices on a network. In other words, the session layer controls the dialogues or nature of communications between network devices on the network. The session layer may also establish checkpointing, adjournment, termination, and restart procedures.

Presentation layer 312 can provide translation for communications between the application and network layers. In other words, this layer may encrypt, decrypt and/or format data based on data types known to be accepted by an application or network layer.

Application layer 314 interacts directly with software applications and end users, and manages communications between them. Application layer 314 can identify destinations, local resource states or availability and/or communication content or formatting using the applications.

Intra-network connection components 322 and 324 are shown to operate in lower levels, such as physical layer 302 and link layer 304, respectively. For example, a hub can operate in the physical layer, a switch can operate in the physical layer, and a router can operate in the network layer. Inter-network connection components 326 and 328 are shown to operate on higher levels, such as layers 306-314. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system, controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

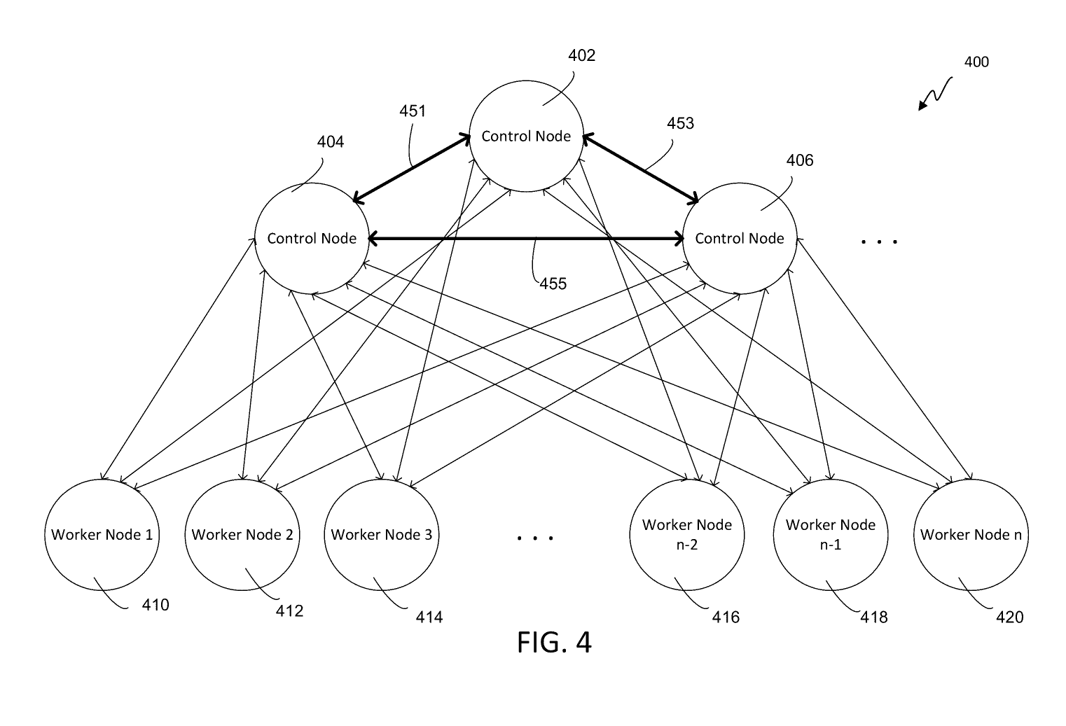

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it, and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server or computer may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be receive or stored by a machine other than a control node (e.g., a Hadoop data node).

Control nodes may maintain knowledge of the status of the nodes in the grid (i.e., grid status information), accept work requests from clients, subdivide the work across worker nodes, coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project code running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most efficiently and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes). The primary control node may be provided with a list of other nodes (e.g., other machines, computers, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined period of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server or computer, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recent saved checkpoint of their status and re-start the project from that checkpoint to minimize lost progress on the project being executed.

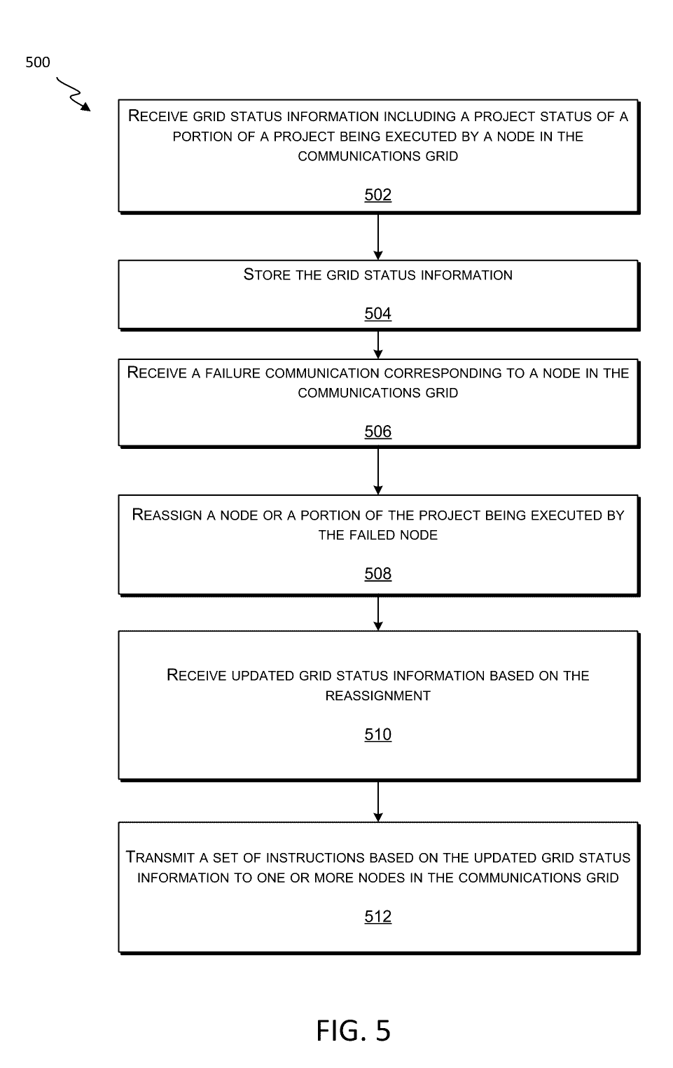

FIG. 5 illustrates a flow chart showing an example process 500 for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

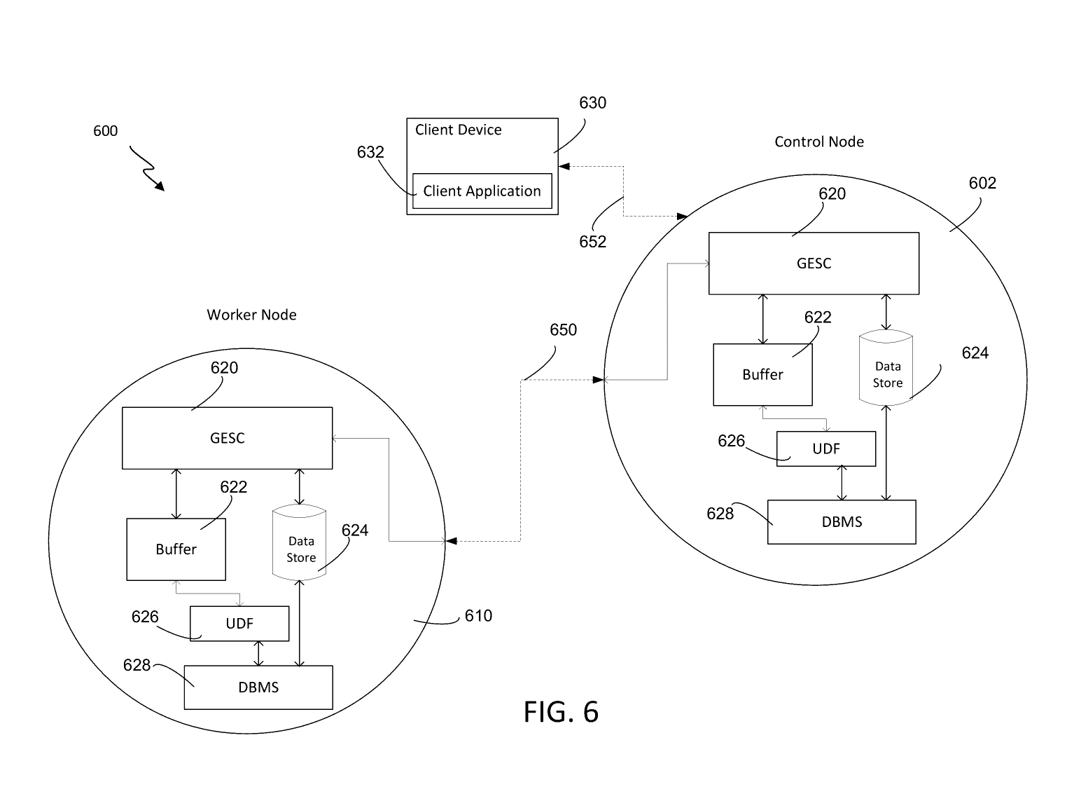

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 comprise multi-core data processors. Each node 602 and 610 includes a grid-enabled software component (GESC) 620 that executes on the data processor associated with that node and interfaces with buffer memory 622 also associated with that node. Each node 602 and 610 includes a database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DMBS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client device 630. More specifically, control node 602 may communicate with client application 632 hosted by the client device 630 to receive queries and to respond to those queries after processing large amounts of data.

DMBS 628 may control the creation, maintenance, and use of database or data structure (not shown) within a nodes 602 or 610. The database may organize data stored in data stores 624. The DMBS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

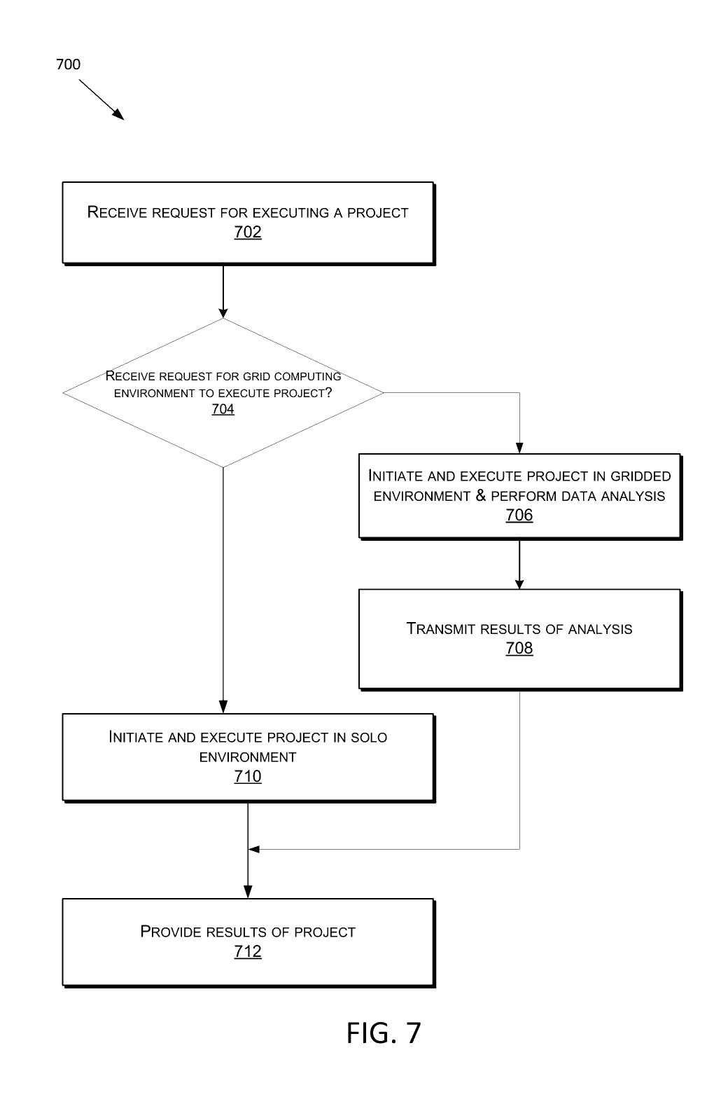

FIG. 7 illustrates a flow chart showing an example method 700 for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project. The results of the project can be provided at block 712.

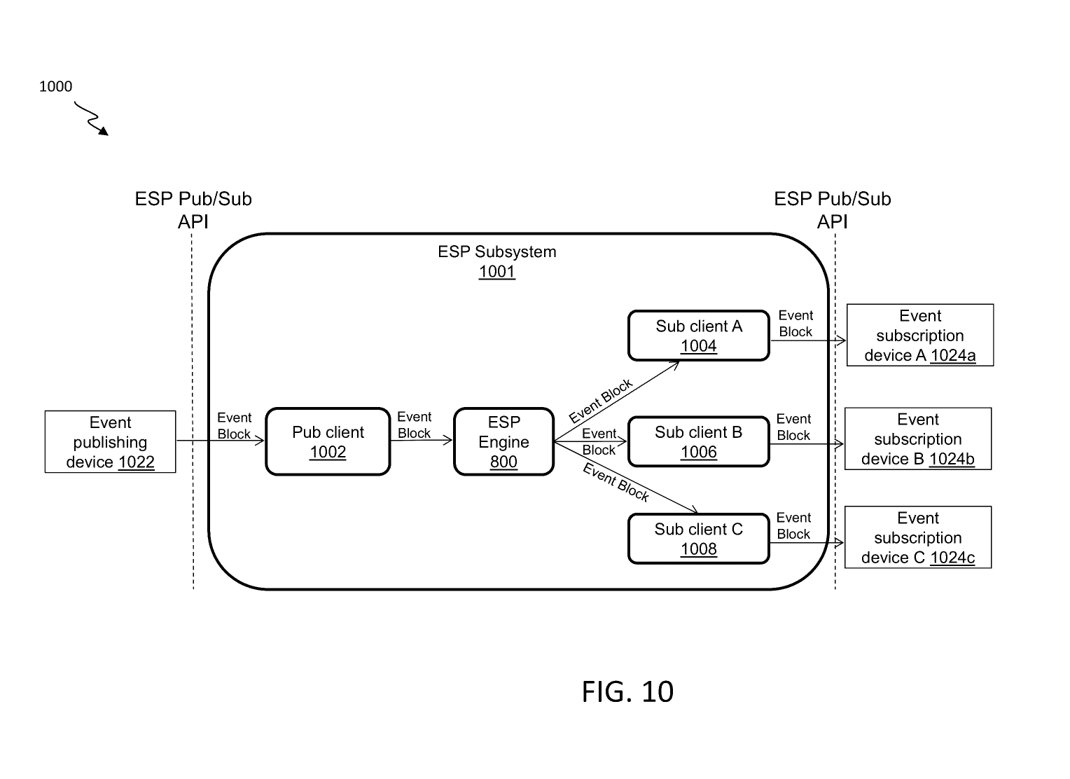

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

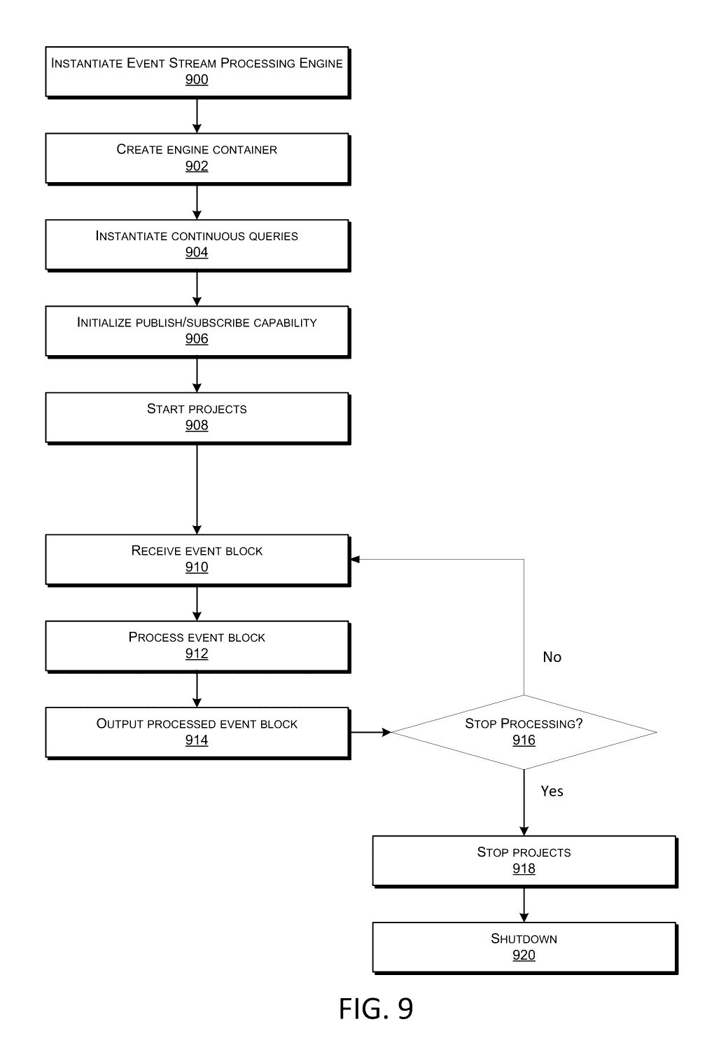

FIG. 9 illustrates a flow chart showing an example process including operations performed by an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 1001, event publishing device 1022, an event subscribing device A 1024a, an event subscribing device B 1024b, and an event subscribing device C 1024c. Input event streams are output to ESP device 1001 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 806, and subscribing client C 808 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 804, subscribing client B 806, and subscribing client C 808 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a computer-readable medium operably coupled to the processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

The aspects described herein with reference to FIGS. 1-10 can be used with the aspects disclosed in U.S. patent application Ser. No. 13/772,200 filed Feb. 20, 2013, entitled “Computer-Implemented Systems and Methods for Scenario Analysis,” such as described in further detail herein, which application is hereby incorporated by reference. U.S. patent application Ser. No. 13/772,200 is a continuation application of U.S. patent application Ser. No. 12/611,497 filed Nov. 3, 2009, entitled “Computer-Implemented Systems and Methods for Scenario Analysis,” the entirety of which is herein incorporated by reference

FIG. 11 depicts at 1100 a computer-implemented environment wherein users 1102 (e.g., via network devices) can interact with a scenario analysis handler 1104 (e.g., scenario analysis manager) hosted on one or more servers 1106 through a network 1108. The system 1104 contains software operations or routines for implementing a scenario analysis handler that performs multiple scenarios based upon time series data. The users 1102 can interact with the system 1104 through a number of ways, such as over one or more networks 1108. One or more servers 1106 accessible through the network(s) 1108 can host the scenario analysis handler 1104. It should be understood that the scenario analysis handler 1104 could also be provided on a stand-alone computer for access by a user.

The scenario analysis handler 1104 can generate possible values (e.g., one or more future values) for a first variable (e.g., output variable) based on past values of the first variable and a second variable (e.g., input variable) as well as proposed future values (e.g., generated possible values) of the second variable. The scenario analysis handler 1104 can further enable multiple scenarios to be generated and simultaneously compared. Each scenario may vary in many factors, such as the model used. In an example, a user 1102 may want to hypothesize the effect on an output variable that may occur in response to a manipulation of an input variable. An example of a suitable output variable is weekly profits for a region of retail stores and an example of a suitable input variable is a product pricing arrangement. After selection of a model, past time-series data relating the input and output variables is provided to the model for training such as via linear regression or other statistical processes. Data is then input as to one or more possible values of the input variable. For example, one desired scenario may raise certain values (e.g., prices) 10%, one scenario may lower the values 15%, one scenario may lower the values by 5% each week for 3 weeks, and one scenario may keep values the same. The scenario analysis handler receives this future hypothetical data for the input variable and determines predicted values for the output variable for each of the desired scenarios. Each of the predicted values for each of the scenarios may be presented for the three weeks in the form of a line graph or other type of graph. A user 1102 may select one of the scenario predictions that the user thinks is most likely to match future results and may persist that prediction for use in other calculations. For example, a user 1102 may decide to lower the values 15% and may, thus, select the scenario prediction associated with the 15% reduction when generating possible values for output variables (e.g., possible profits for the associated region).

A scenario provides a determination as to how a generated collection of possible values for one or more output variables may change when one manipulates the possible (e.g., future) values of one or more independent or dependent variables. A scenario analysis handler may be configured to perform one or more of a variety of functions related to a given scenario. In a first mode of operation, as described above, a prediction of a possible value of a first dependent variable is generated by the scenario analysis handler based on past values of the first dependent variable, past values of one or more independent variables, and one or more predicted values of the one or more independent variables. In a second, goal-seeking, mode of operation, a determination of possible values for one or more first dependent variables is determined to reach a desired value for an independent variable. For example, in a goal-seeking operation, the scenario analysis handler may determine a possible value of an input variable that will yield a desired possible value of an output variable, based on past values of the input and output variables and the desired possible value of the output variable. The scenario analysis handler may also perform in an optimization mode where one or more first future variable values are determined to maximize or minimize a second possible value. For example, a scenario analysis handler may determine possible values of an input variable to maximize an output variable.

A scenario analysis handler may also be utilized in the testing of models using hold-out data. Hold-out data consists of a set of past data that is not used in training a model but is instead used in testing the accuracy of a model. Thus, possible value for a first variable may be generated by the scenario analysis handler based on a first set of past data for the first variable and a second variable as well as a second set of hold-out past data for the second variable, where the second set of hold-out past data is subsequent to the first set of past data. Thus, the known, hold-out data for the second variable is treated as a “subsequent” value of the second variable. The scenario analysis handler then generates a possible “subsequent” value of the first variable based on the “subsequent” hold-out data for the second variable. The possible “subsequent” value of the first variable determined by the scenario analysis handler may then be compared to the actual hold-out data for the first variable to determine the accuracy of the model compared to real-life results.

With reference back to FIG. 11, the scenario analysis handler 1104 can be an integrated web-based analysis tool that provides users flexibility and functionality for performing scenario analyses or can be a wholly automated system. One or more data stores 1110 can store the data to be processed by the system 1104 as well as any intermediate or final data generated by the system 1104. For example, data store(s) 1110 can store project definition data 1112 that describes relationships between a project, scenarios within the project, and a model associated with a scenario. The one or more data stores 1110 may also contain time series data 1114 representative of past values of one or more variables and may also contain possible values of the one or more variables. Examples of data store(s) 1110 can include relational database management systems (RDBMS), a multi-dimensional database (MDDB), such as an Online Analytical Processing (OLAP) database, etc.

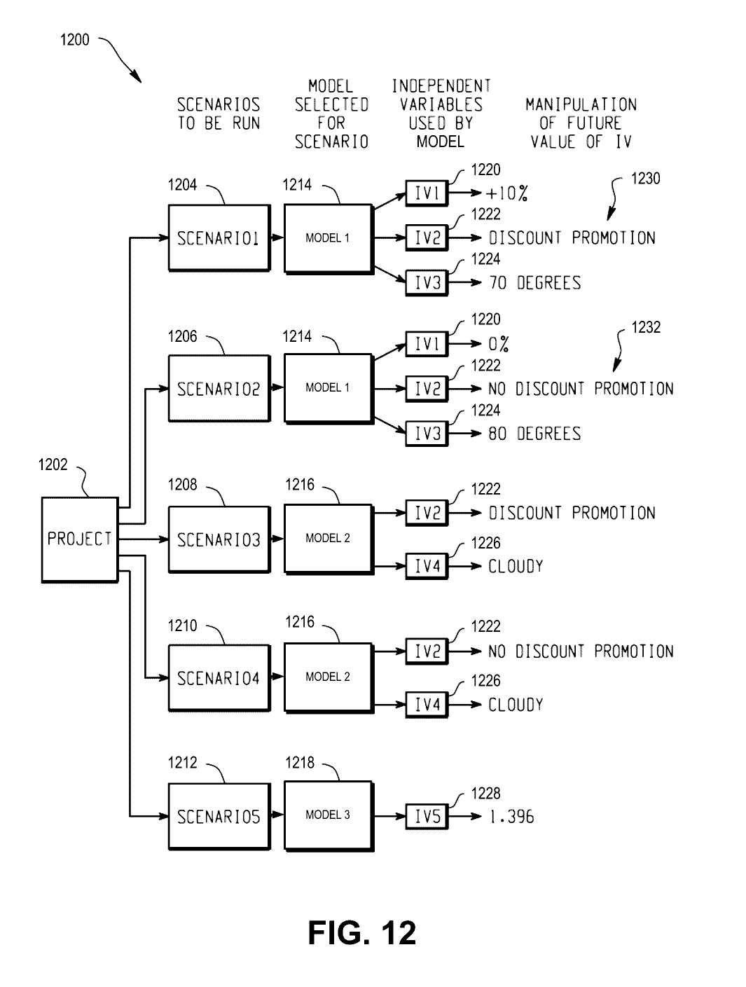

FIG. 12 is a block diagram depicting at 1200 an example project 1202 handled by a scenario analysis handler. The project 1202 can include a number of scenarios, each of which relates to a selected model and independent variable(s). When run, a scenario can provide possible values for an output variable based on the selected model and independent variable(s). Five scenarios 1204, 1206, 1208, 1210, 1212 to be executed are associated with the project 1202. In the example of FIG. 12, model 1 1214 is associated with scenario 1 1204 and scenario 2 1206, model 2 is associated with scenario 3 1208 and scenario 4 1210 and model 3 1218 is associated with scenario 5 1212. One or more independent variables (also referred to as “input variables”) are associated with each model. Independent variable (IV) 1 1220 related to advertising dollars spent, IV2 1222 related to a discount promotion, and IV3 1224 related to the temperature are associated with model 1 1214; IV 2 1222 and IV 4 1226 related to the weather are associated with model 2 1216; and IV5 1228 related to an exchange rate of the dollar is associated with model 3 1218. As shown in FIG. 12, independent variables associated with the models may overlap between models at varying levels (i.e., some, all, or not at all). A project 1202 also includes manipulations for some or all of the independent variables for each scenario. For example, in scenario 1 1204, advertising dollars spent are increased 10%, a discount program is implemented, and the projected temperature is set to 70 degrees, as shown at 1230. In scenario 2 1206, advertising expenditures remain unchanged, no discount program is implemented, and the projected temperature is set to 80 degrees, as shown at 1232. After receipt of inputs defining a project and manipulations to be made for each scenario in the project, a scenario analysis handler generates possible values of one or more variables based on the desired manipulations in the defined scenarios and may display those possible values to a user.

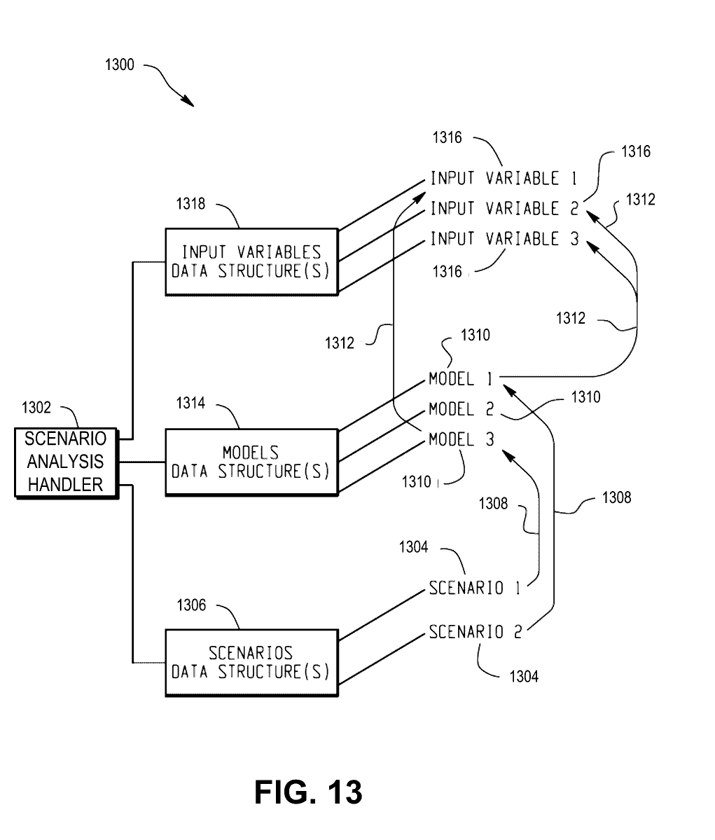

The scenario analysis handler provides for quick and easy selection of one or more models for a project, selection of input data and future scenario data for utilization by the selected models, and execution of efficient and accurate scenario determinations by managing a number of data structures describing the state of a project. FIG. 13 is a block diagram depicting at 1300 relationships among scenarios, models, and input variables which are managed by a scenario analysis handler 1302. A scenario analysis handler 1302 manages one or more scenarios 1304 via a scenarios data structure 1306. The scenarios data structure 1306 contains one or more model links 1308 that identify which models 1310 are associated with which scenarios. For example, model links 1308 contained within the scenarios data structure may provide one-to-one links identifying a model associated with each scenario. The scenario analysis handler 1302 may also manage input variable links 1312 contained within a models data structure 1314. For example, a model record within the models data structure 1314 may include one-to-many input variable links 1312 identifying one or more predictive input variables 1316 associated with each model 1310.

Each of the data structures 1306, 1314, 1318 may also contain other information about certain entities at their level. For example, the scenario data structure 1306 may include data on each scenario 1304 such as a scenario name, a scenario date of creation, a scenario description, as well as other data. The models data structure 1314 may contain data on each model 1310 such as a model name, a model date of creation, a model description, a model input data type, a model output data type, as well as other data. The input variables data structure 1318 may contain data on each input variable 1316 such as an input variable name, an input variable type, and input variable description, as well as other data.

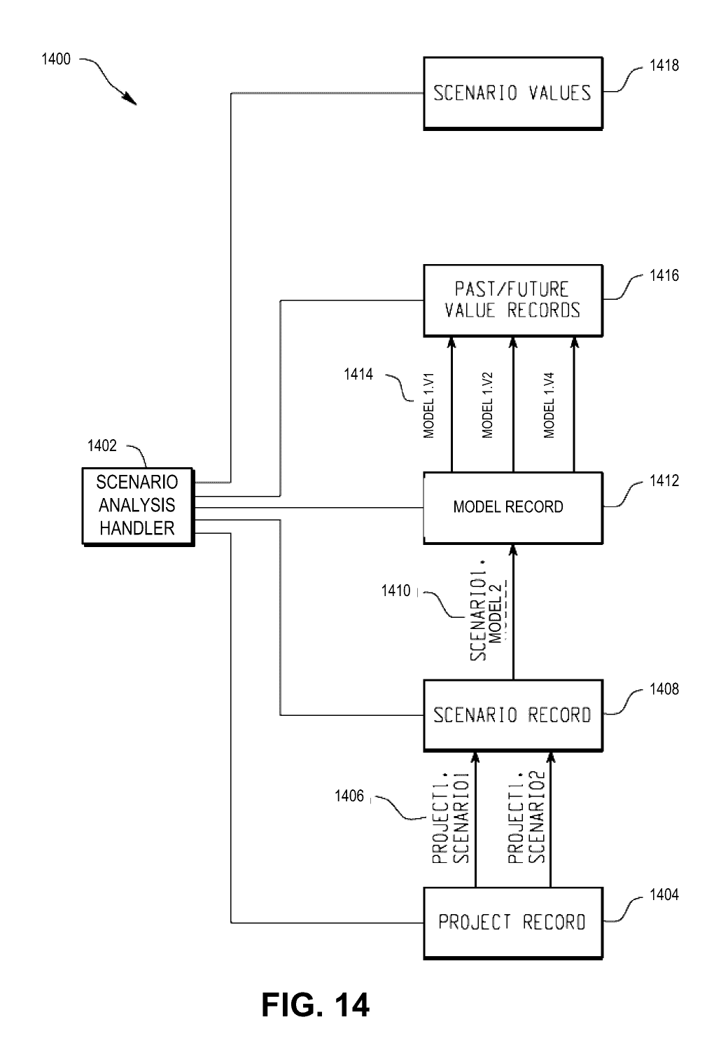

FIG. 14 is a block diagram depicting at 1400 data records managed by a scenario analysis handler 1402. A scenario analysis handler 1402 manages one or more project records 1404, each project containing one or more scenarios. A project record contains one-to-many scenario links 1406 between a project identified by the project record 1404 and one or more scenarios associated with the project. The scenario analysis handler 1402 also controls one or more scenario records 1408.

Each scenario record 1408 identifies a model associated with the scenario via a model link 1410 contained in the scenario record 1408. The scenario analysis handler 1402 further manages one or more model records 1412. A model record contains one-to-many input variable links 1414 between a model identified by the model record 1412 and one or more variables associated with the model. The scenario analysis handler 1402 further administers a plurality of past/possible value records 1416. The past/future records may, for example, contain time series data associated with the variables identified by the input variable links 1414 associated with a model record 1412. The past/possible value records may include past and/or predicted possible values of dependent and/or independent variables referenced by a model record 1412. The scenario analysis handler 1402 may also control scenario values 1418 that contain possible values determined by the scenario analysis handler 1402 in running a scenario analysis identified by the project records 1404, scenario records 1408, model records 1412, and past/possible value records 1416.

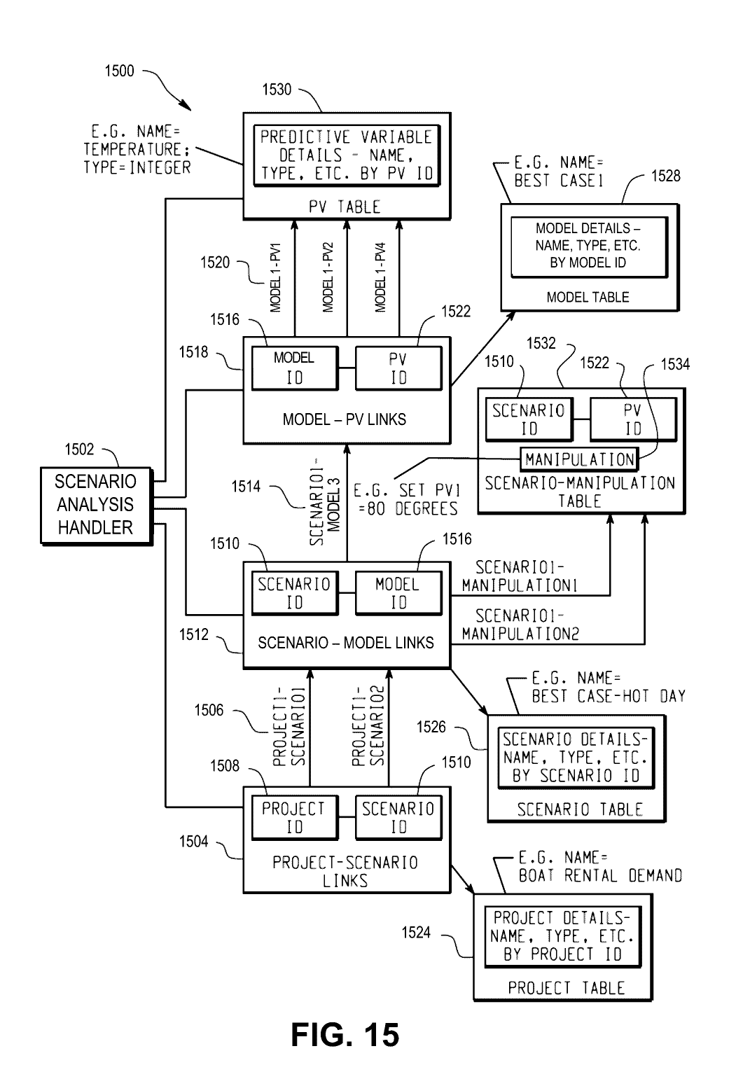

FIG. 15 is a block diagram depicting at 1500 example data structures managed by a scenario analysis handler 1502. In managing one or more projects, a scenario analysis handler 1502 may control several link-tables identifying associations among projects, scenarios, models, and variables. For example, the scenario analysis handler 1502 may manage a project-scenario links table 1504. The project-scenario links table 1504 contains scenario links 1506 between projects and one or more scenarios associated with each project by project ID 1508 and scenario ID 1510. The scenario analysis handler 1502 may further control a scenario-model links table 1512. The scenario-model links table 1512 contains model links 1514 between a scenario and a model associated with the scenario by scenario ID 1510 and model ID 1516. The scenario analysis handler 1502 may further manage a model-predictive variable (PV) links table 1518. The model-PV table 1518 contains predictive variable links 1520 between a model and predictive variables associated with the model by model ID 1516 and PV ID 1522.

The scenario analysis handler 1502 may further manage descriptive tables and records that provide information describing entities at each level (i.e., project level, scenario level, model level, variable level). The descriptive information may be incorporated into the links records described above or may be broken into separate data structures as shown in FIG. 15. For example, a project table 1524 may include records identifying a project name, project type, and other project information that it indexed by project ID 1508. A scenario table 1526 may include records identifying a scenario name, a scenario type, and other scenario information that it indexed by scenario ID 1510. A model table 1528 may include records identifying a model name, a model type, and other model information that it indexed by model ID 1516. A predictive variable table 1530 may include records identifying a predictive variable name, a predictive variable data type, and other predictive variable information that it indexed by PV ID 1522.

The scenario analysis handler 1502 may also manage desired manipulations to possible values of the predictive variables. For example, as described above, one scenario may reduce a price variable by 10% per week for three weeks to examine the effect on regional profits. Such a manipulation may be stored in a scenario-manipulation table 1532 that identifies one or more future manipulations to be made to a predictive variable over one or more future time periods. A scenario-manipulation table 1532 may store the desired manipulation 1534 (e.g., set a predictive variable, temperature, to 80 degrees Fahrenheit for future time period number 1, in predicting amusement park attendance) by scenario ID 1510 and predictive variable ID 1522. Records of the scenario-manipulation index may also be indexed by a manipulation index (not shown) which may be linked from the scenario-model links table 1512 or other location.

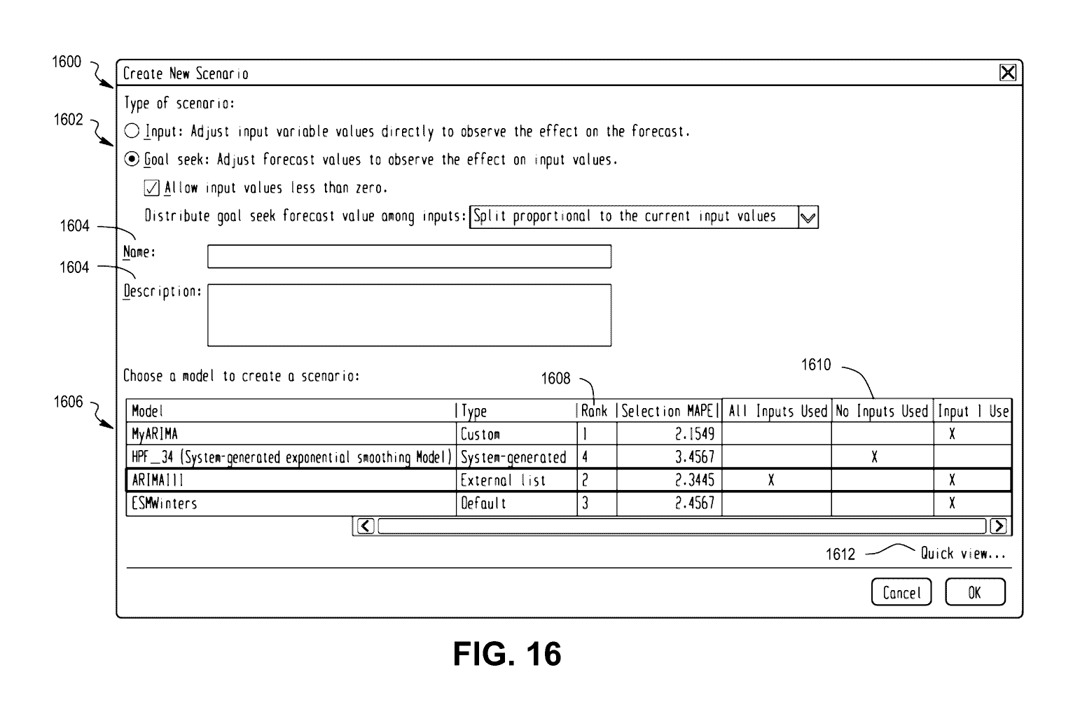

FIG. 16 is a screenshot depicting at 1600 a graphical user interface for providing input data defining a new scenario for incorporation into a project. A user is provided a scenario type prompt 1602 offering options on the type of scenario to be generated. For example, in an input type scenario, possible values of one or more independent variables are manipulated to determine predicted possible values of one or more dependent variables. In a goal seeking scenario, possible values of one or more dependent variables are manipulated to determine predicted values of independent variables that would generate in the identified dependent variable result. A new scenario interface 1600 may also include input mechanisms 1604 for entering descriptive data about the scenario such as a scenario name and a text description of the scenario.

Further, a new scenario interface 1600 includes a model selection interface area 1606 for displaying models and associated information about the models and for accepting selection of a model to associate with the scenario. The model selection interface area 1606 provides data about a set of models available for selection for a scenario. Data provided may include a name and model type. The models may be ranked, as shown at 1608, based on a quality metric. The quality metric may be based on one or more of a number of factors including prior user recommendations, hold-out data testing accuracy, percentage of times data from the model is persisted for subsequent use, as well as others. The model selection interface area 1606 also may offer data regarding variables associated with each model, as shown at 1610. The associated variables data 1610 aides a user in selecting a model by identifying the variables that may be predicted by a model as well as to which variables a model is sensitive. Thus, if one wishes to analyze the effect of temperature on amusement park attendance, then one would use the variables data 1610 to narrow selection choices to those models that are sensitive to the temperature variable. A new scenario interface 1600 may also include a quick view 1612 indicator for providing expanded information related to the model selection interface area 1606.

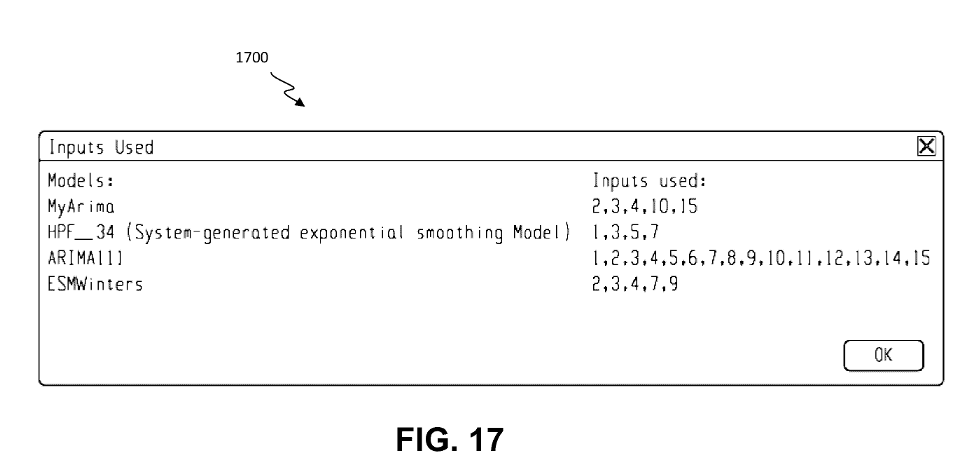

FIG. 17 is a screenshot depicting at 1700 a graphical user interface for providing expanded details of models available for selection in a scenario. Such an interface may be accessed, for example, through selection of an expanded information indicator as depicted in FIG. 16 at 1606. The expanded models details interface 1700 displays a listing of models available for selection in a scenario as well as an exhaustive list of variables associated with each model. Such an interface enables easy identification and comparison of the variables to which a model is sensitive. Further details associated with each model may also be displayed on expanded models details interface 1700 such as model description, model type, model ranking, as well as other information.

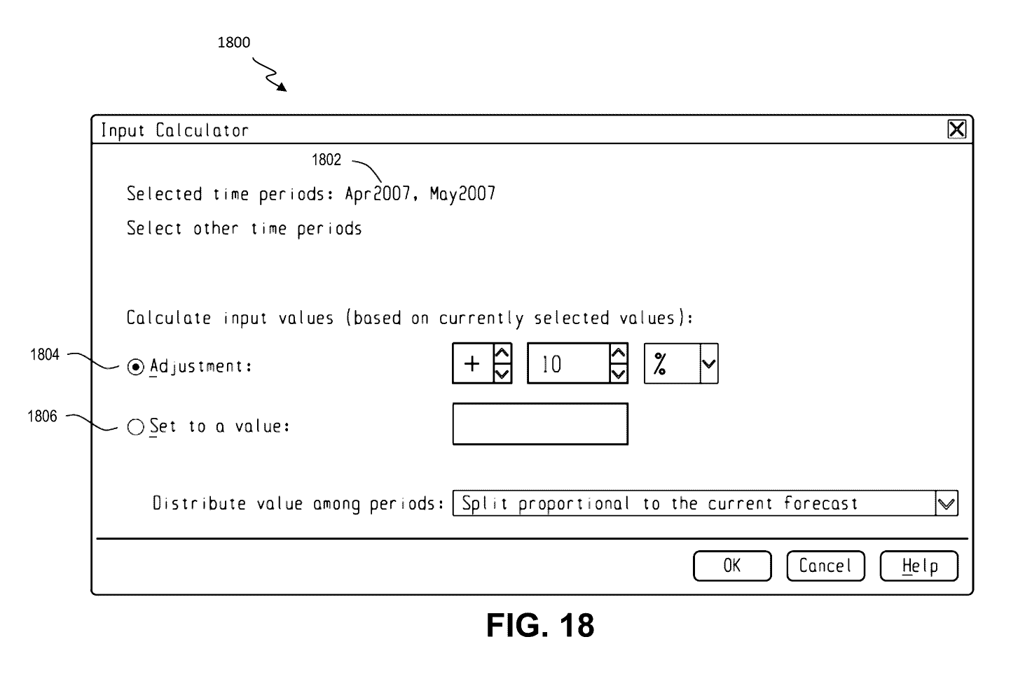

FIG. 18 is a screenshot depicting at 1800 a graphical user interface for identifying desired manipulations for a variable in a scenario. For an identified set of time periods, as shown at 1802, a variable's possible value may be adjusted by a percentage or other measure, as shown at 1804, or set to a particular value, as shown at 1806. This possible value data may be used by the scenario analysis handler in predicting possible values of other variables. Manipulation data for variables associated with models in scenarios may be received by a scenario analysis handler by other mechanism such as a spreadsheet or a database. Manipulation data could also originate from past collected time-series data in cases where a portion of the past collected time-series data is designated as hold-out data for model accuracy analysis or other procedures.

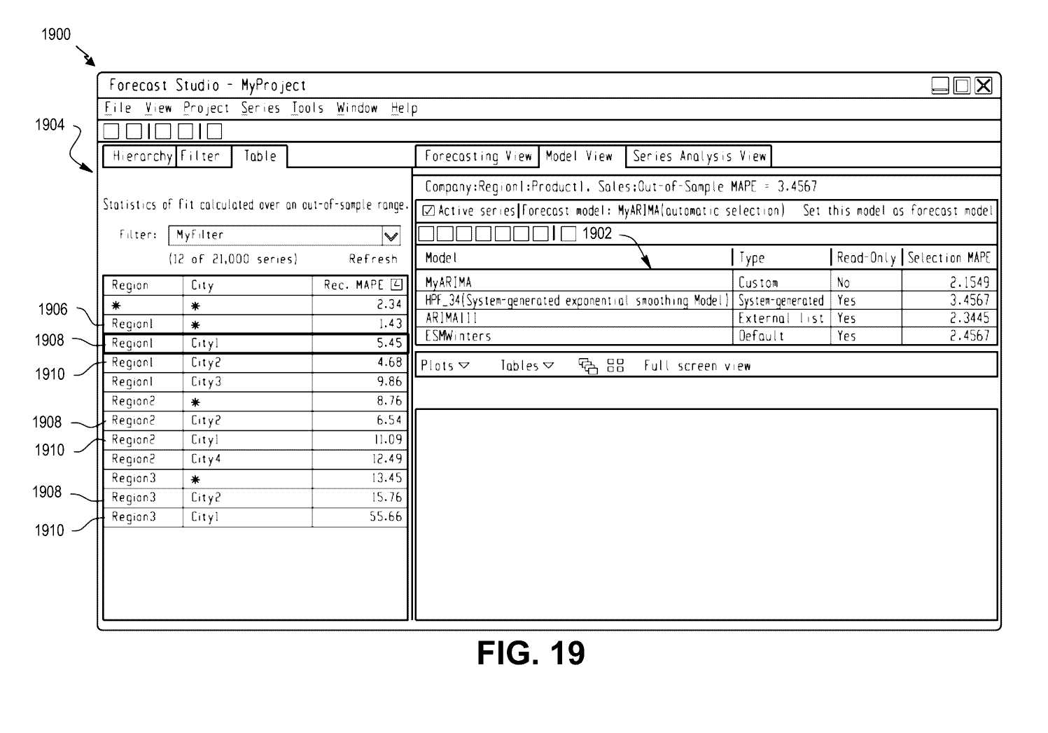

FIG. 19 is a screenshot depicting at 1900 a graphical user interface for providing details of models associated with a project. The model view 1900 provides a listing 1902 of models that have been selected, such as via the new scenario interface of FIG. 16, as being associated with a scenario in a project. The listing provides data regarding each of the associated models that may include a model name, model type, model description, variables associated with a model, as well as other information. A model view 1900 may also include a hierarchy selection region 1904 for selection of a hierarchical level at which to make scenario determinations. For example, a user may select any of a number of levels and branches of the hierarchy at which to analyze, such as a top level 1906 a regional level 1908 or an entity at a city level 1910. Hierarchies may be divided into any number of levels. For example, the hierarchy shown at 1904 could be further broken down into a district level and an individual store level for providing predictions at each of these aggregate levels. Hierarchical data storage for an organization is described in U.S. patent application Ser. No. 12/412,046, entitled “Systems and Methods for Markdown Optimization when Inventory Pooling Level is above Pricing Level,” filed on Mar. 26, 2009, the entirety of which is herein incorporated by reference.

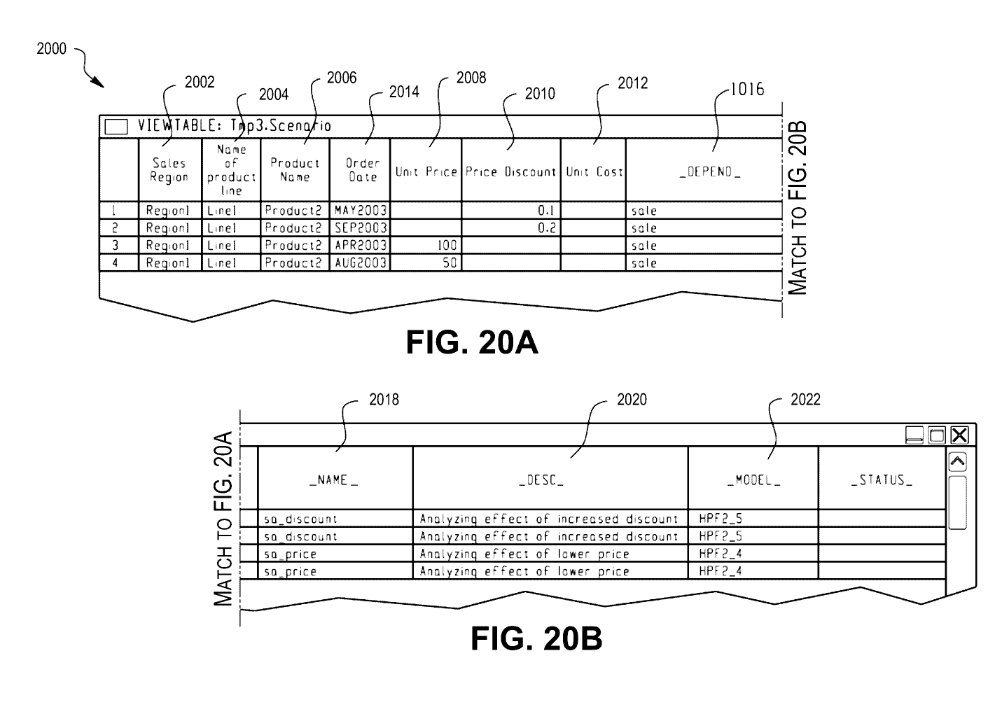

FIGS. 20A and 20B are data tables depicting at 2000 example data associated with a plurality of scenarios within a project. For each scenario listed, a hierarchical level in both the area and product line hierarchies is identified at 2002 and 2004, 2006, respectively. Columns 2008, 2010, and 2012 identify manipulations for possible values of variables associated with each scenario and a time period for each of the manipulations to be applied is recited at 2014. Column 2016 identifies a dependent variable associated with a model selected for each scenario, and columns 2018, 2020, and 2022 include a model name, model description, and model identifier, respectively.

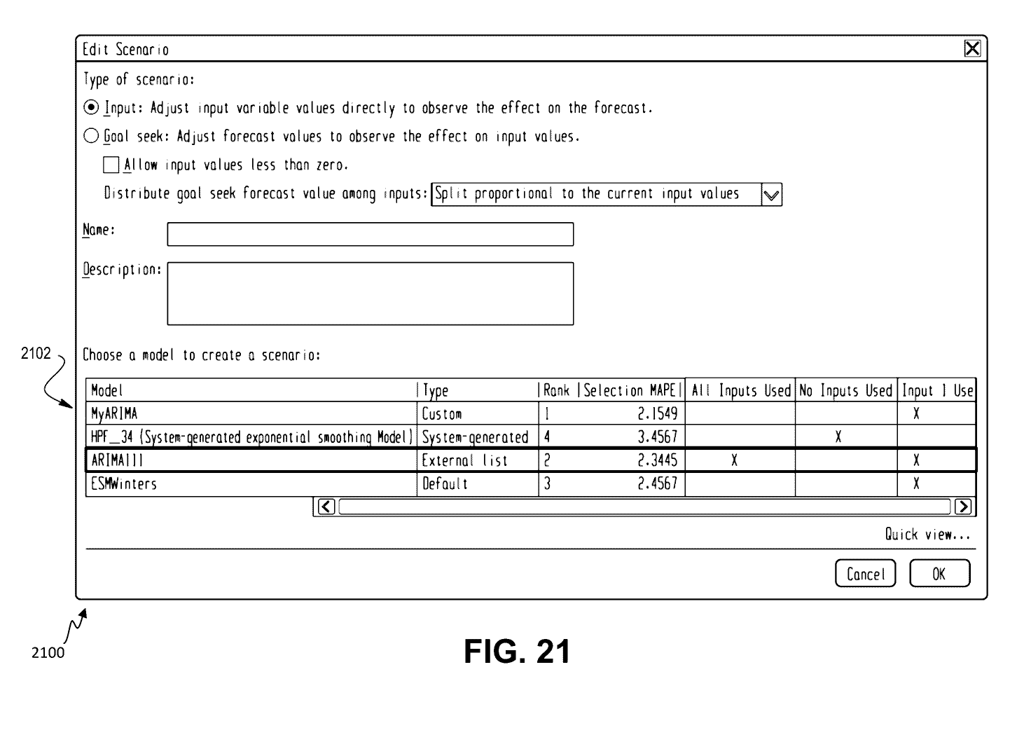

FIG. 21 is a screenshot depicting at 2100 a graphical user interface for editing a model associated with a scenario. FIG. 21 offers a similar interface to the model selection interface of FIG. 16, while offering a mechanism for a user to select a new model to associate with a scenario. Model data including a model name, type, ranking, associated variables and other model data may be provided to a user, as shown at 2102. A user may review a previous model selection and change or confirm that previous decision in addition to editing scenario details such as a scenario name and scenario description.

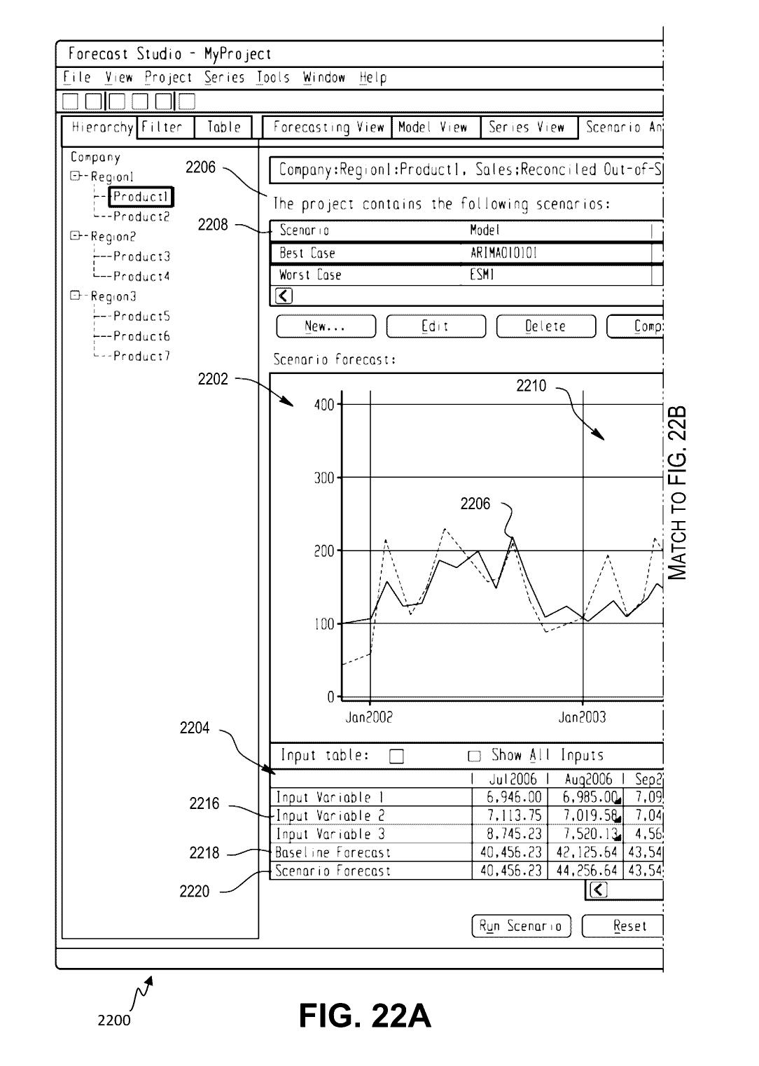

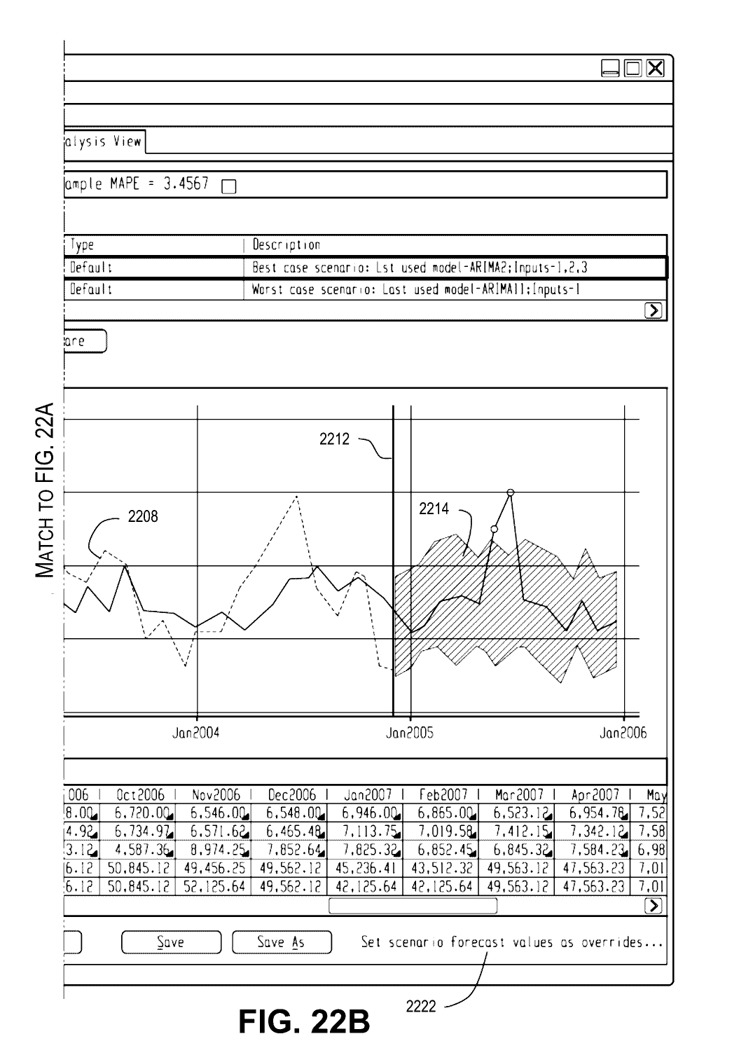

FIGS. 22A and 22B are screenshots depicting at 2200 a graphical user interface for displaying determinations of possible values for one or more scenarios. Following definition of one or more scenarios, associated models, and past and possible values of one or more variables, one or more possible values of a variable of interest are determined by a scenario analysis handler. The one or more possible values for different scenarios may be displayed simultaneously in a graph form 2202, tabular form 2204, or other form. In the example of FIG. 22A, two determined future scenario value sets are displayed, one corresponding to a scenario identified as “Best Case” 2206 and another identified as “Worst Case” 2208. The graph depiction of the two scenarios 2206, 2208 depicts past time-series data 2210 to the left of a forecast date line 2212. To the right of the forecast date line 2212, the graph depiction displays a plurality of possible values for each of the two scenarios 2206, 2208. The graph depiction may also include a confidence interval 2214 associated with one of the forecasts. In the tabular data depiction 2204, each of the instructed possible values of input variables 1, 2, and 3 are listed at 2216 for each period of the scenario. Also included are previously identified values of a baseline forecast 2218 for the metric being predicted by the current scenario, as well as the determined possible values of the variable of interest as a scenario forecast at 2220. Should a user decide that a scenario forecast provides a better prediction than an existing baseline forecast, then the scenario forecast may be persisted as the baseline forecast going forward through selection of a set scenario forecast values as overrides indicator, depicted at 2222. For example, the scenario forecast values 2220 could be persisted as the persisted forecast for the Region 1/Product 1 level of a data hierarchy as indicated at 2222.

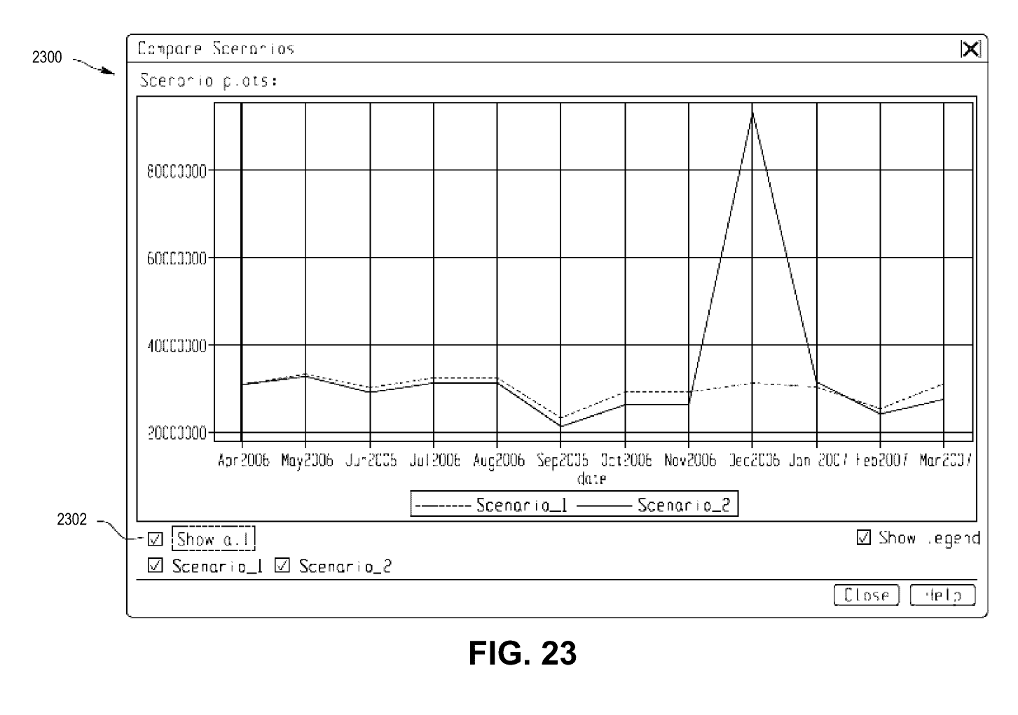

FIG. 23 is a screenshot depicting at 2300 a graphical user interface for displaying a comparison of possible values associated with multiple scenarios simultaneously. The scenario display interface 2300 provides a simultaneous comparison among a plurality of scenarios to a user. A user may be able to toggle which of the plurality of scenarios are to be displayed via data controls 2302.

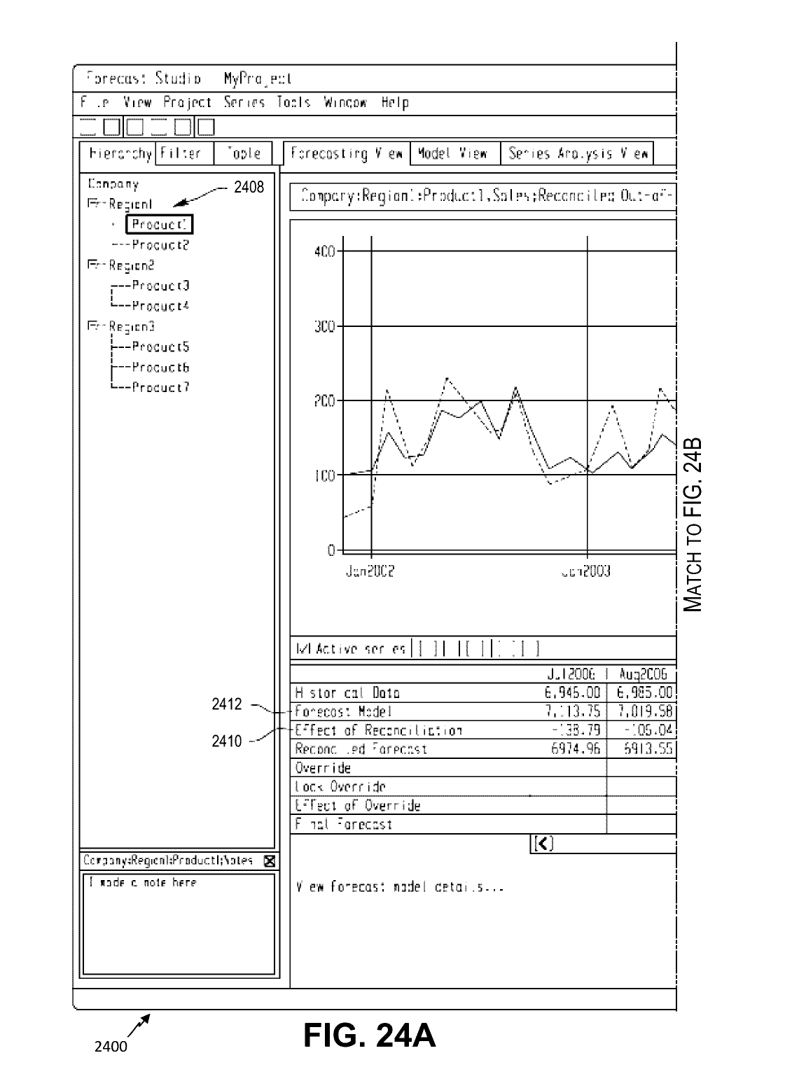

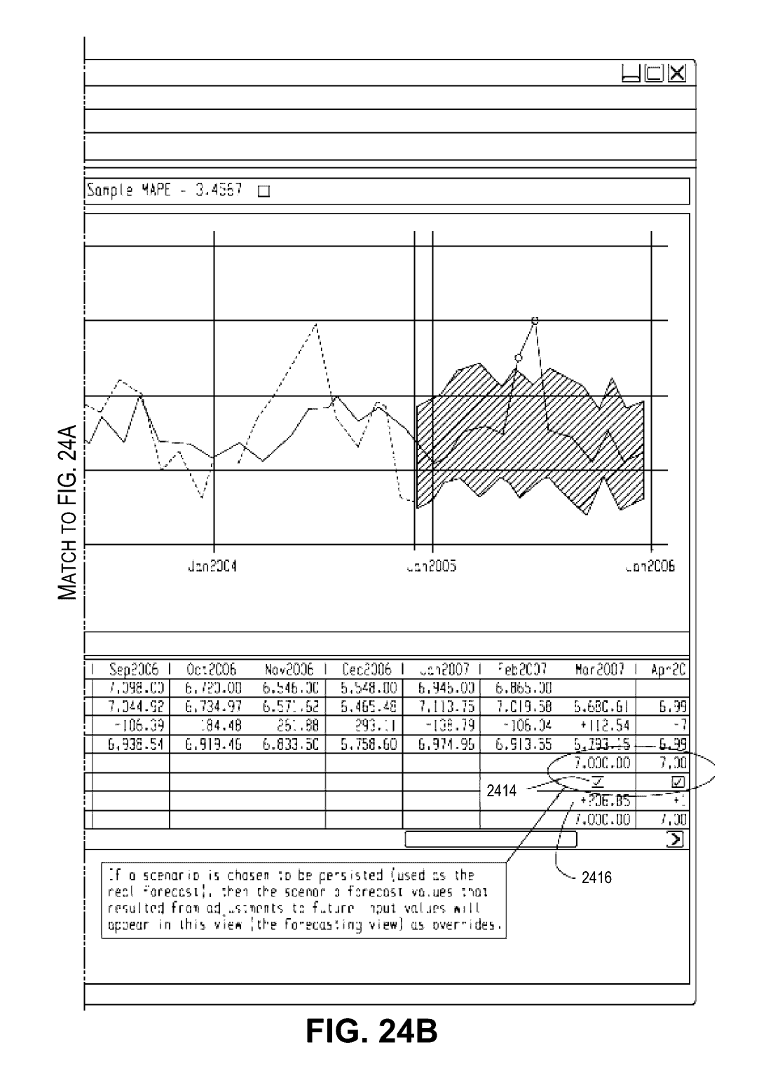

FIGS. 24A and 24B are screenshots depicting at 2400 a graphical user interface for displaying one or more scenarios in comparison with a prior forecast. A forecast display region 2402 provides a graphical depiction of one or more possible values of a variable at 2404 as well as past values at 2406. Scenarios may be depicted at a desired level of a data hierarchy as indicated by the hierarchy selection indicators 2408. The user interface 2400 also includes comparison data associated with both the possible values of the selected scenario at 2410 and a prior existing forecast at 2412. The forecast display region further offers override selection indicators 2414 and override result data at 2416. The override result data 2416 offers an indication of the effect on the prior existing forecast if the current scenario is selected to replace the prior existing forecast. For example, if the March 2007 scenario value of 7,000 is chosen as an override to the reconciled forecast of 6,793.15, then the effect of the override is 206.85, as indicated at 2416.

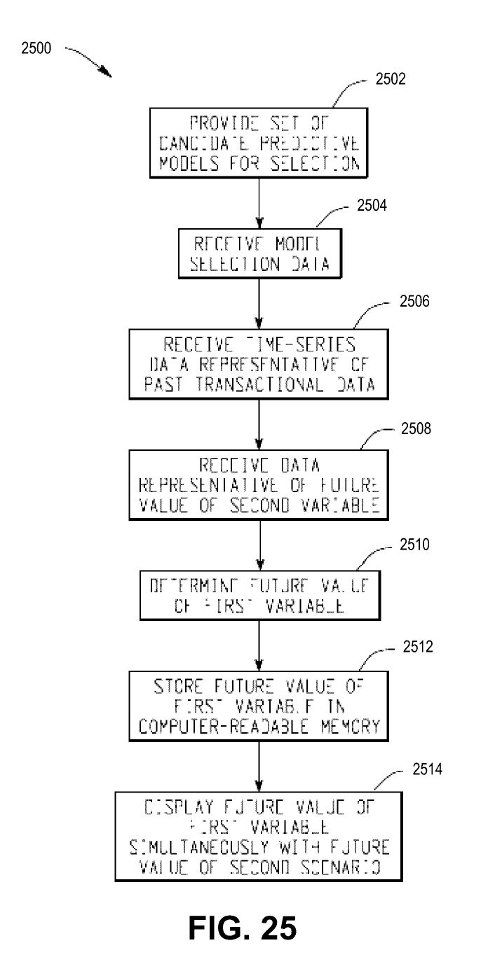

FIG. 25 is a flow diagram depicting at 2500 a computer-implemented method of implementing a scenario analysis handler that performs multiple scenarios based upon time series data that is representative of transactional data and displays results of the multiple scenarios simultaneously. Software instructions can be specially configured to perform the operation in the manner depicted in this figure. At 2502, a set of candidate predictive models is provided for a first scenario for selection where the set of candidate predictive models includes an identification of which variables are associated with a model. Model selection data is received at 2504 where a selected model is configured to predict a possible value of a first variable based at least in part on values of a second variable. Time-series data is received at 2506 from a computer-readable memory that represents past transactional activity of the first variable and the second variable, and data representative of a possible value of the second variable is received at 2508. At 2510, the possible value of the first variable is determined using the selected model, the time-series data, and the possible value of the second variable, and the possible value of the first variable for the first scenario is stored in a computer-readable memory at 2512. At 2514, the possible value of the first variable is displayed simultaneously with a possible value of the second scenario.

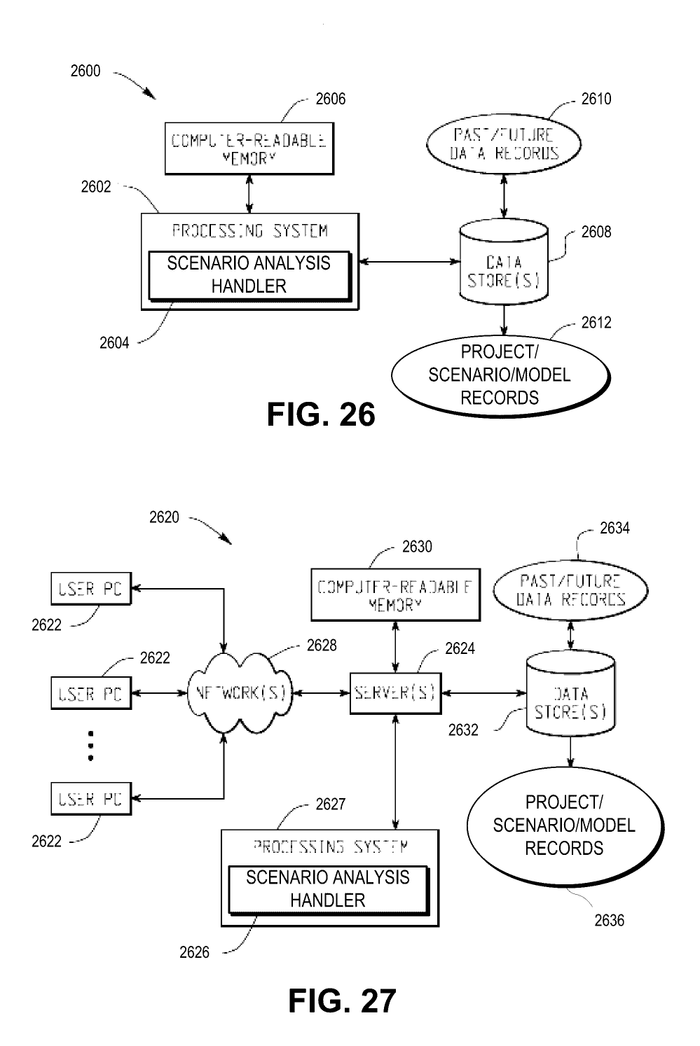

FIGS. 26, 27, and 28 depict example systems for use in implementing a scenario analysis handler. For example, FIG. 26 depicts an exemplary system 2600 that includes a stand alone computer architecture where a processing system 2602 (e.g., one or more computer processors) includes a scenario analysis handler 2604 being executed on it. The processing system 2602 has access to a computer-readable memory 2606 in addition to one or more data stores 2608. The one or more data stores 2608 may contain past/future data records 2610 as well as project/scenario/model records 2612.

FIG. 27 depicts a system 2620 that includes a client server architecture. One or more user PCs 2622 accesses one or more servers 2624 running a scenario analysis handler 2626 on a processing system 2627 via one or more networks 2628. The one or more servers 2624 may access a computer readable memory 2630 as well as one or more data stores 2632. The one or more data stores 2632 may contain past/future data records 2634 as well as project/scenario/model records 2636.

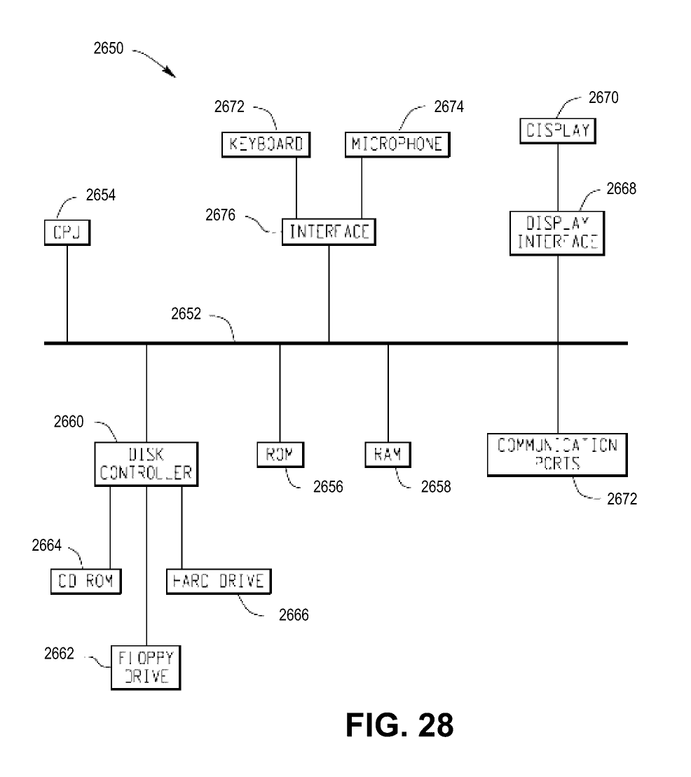

FIG. 28 shows a block diagram of exemplary hardware for a stand alone computer architecture 2650, such as the architecture depicted in FIG. 26, that may be used to contain and/or implement the program instructions of system embodiments of the present invention. A bus 2652 may serve as the information highway interconnecting the other illustrated components of the hardware. A processing system 2654 labeled CPU (central processing unit) (e.g., one or more computer processors), may perform calculations and logic operations required to execute a program. A processor-readable storage medium, such as read only memory (ROM) 2656 and random access memory (RAM) 2658, may be in communication with the processing system 2654 and may contain one or more programming instructions for performing the method of implementing a scenario analysis handler. Optionally, program instructions may be stored on a computer readable storage medium such as a magnetic disk, optical disk, recordable memory device, flash memory, or other physical storage medium. Computer instructions may also be communicated via a communications signal, or a modulated carrier wave.

A disk controller 2660 interfaces one or more optional disk drives to the system bus 2652. These disk drives may be external or internal floppy disk drives such as 2662, external or internal CD-ROM, CD-R, CD-RW or DVD drives such as 2664, or external or internal hard drives 2666. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 2660, the ROM 2656 and/or the RAM 2658. Preferably, the processor 2654 may access each component as required.

A display interface 2668 may permit information from the bus 2656 to be displayed on a display 2670 in audio, graphic, or alphanumeric format. Communication with external devices may optionally occur using various communication ports 2672.

In addition to the standard computer-type components, the hardware may also include data input devices, such as a keyboard 2672, or other input device 2674, such as a microphone, remote control, pointer, mouse and/or joystick. Data input devices may be coupled through an interface 2676.

U.S. patent application Ser. No. 11/432,127, entitled “Computer-Implemented Systems and Methods for Defining Events,” describes systems and methods for defining events; the entirety of which is herein incorporated by reference. U.S. patent application Ser. No. 11/431,123, entitled “Computer-Implemented Systems and Methods For Storing Data Analysis Models,” describes systems and methods for storing data analysis models; the entirety of which is herein incorporated by reference. U.S. Pat. No. 7,251,589, entitled “Computer-Implemented System and Method For Generating Forecasts,” describes systems and methods for generating forecasts; the entirety of which is herein incorporated by reference.

As used below, any reference to a series of examples is to be understood as a reference to each of those examples disjunctively (e.g., “Examples 1-4” is to be understood as “Examples 1, 2, 3, or 4”).

Example 1 is a system, comprising one or more data processors; and a non-transitory computer-readable storage medium containing instructions which, when executed on the one or more data processors, cause the one or more data processors to perform operations including: storing a plurality of models, each model being associated with an input variable and an output variable and each model operable to estimate possible values for the output variable associated with that model; storing scenario information, wherein storing scenario information includes associating each of a plurality of scenarios with two or more of the plurality of models; displaying scenario selection information on a graphical interface by individually depicting each of the plurality of scenarios, wherein individually depicting a scenario includes depicting the models that are associated with that scenario, and wherein depicting a model includes indicating the input variable and the output variable associated with that model; receiving a scenario selection input indicating a selected one of the plurality of scenarios; receiving a model selection input indicating a selected one of the plurality of models associated with the selected scenario; receiving input variable information; generating possible values of the input variable associated with the selected model using the input variable information; and generating a collection of values of the output variable associated with the selected model using the selected model and the possible input values.

Example 2 is the system of example 1, wherein the input variable information includes a rate, and wherein generating the possible values uses the rate.

Example 3 is the system of examples 1 or 2, wherein each of the models is further operable to perform goal-seeking, wherein goal-seeking includes calculating values for the input variable associated with the selected model, and wherein calculating is based on assumed values of the output variable associated with the selected model.

Example 4 is the system of example 3, wherein the operations further include: receiving goal-seeking information indicating assumed values of the output variable associated with the selected model; and performing a goal-seeking calculation based on the selected model and the assumed values of the output variable associated with the selected model, wherein performing the goal-seeking calculation includes determining values of the input variable associated with the selected model.

Example 5 is the system of example 4, wherein the selected model includes a mathematical relationship between the input variable associated with the selected model and the output variable associated with the selected model.

Example 6 is the system of example 5, wherein determining values of the input variable associated with the model includes using the mathematical relationship.

Example 7 is the system of examples 1-6, wherein the scenario information includes, for at least one of the plurality of scenarios, a name, a date, or a description.

Example 8 is the system of examples 1-7 wherein the operations further include, for each of the depicted scenarios, storing a name and type of the input variable associated with the scenario.

Example 9 is the system of examples 1-8, wherein the operations further include: storing multiple input variable manipulation options; receiving selection information indicating a selection of one of the multiple input variable manipulation options; altering the possible values of the input variable associated with the selected model, wherein altering is performed based on the selected one of the multiple input variable manipulation options; and generating updated possible values of the output variable associated with the selected model, wherein generating updated possible values includes using the selected model and the altered possible values of the input variable.

Example 10 is the system of examples 1-9, wherein the operations further include displaying a model selection interface, wherein displaying a model selection interface includes displaying, with respect to each of the models, a quality metric representative of that model's performance when evaluated with holdout data.

Example 11 is the system of example 10, wherein displaying a model selection interface further includes displaying, with respect to each of the models, information about the input variable and output variable with which the model is associated.

Example 12 is the system of example 11, wherein each of the multiple models is associated with multiple input variables.

Example 13 is the system of example 12, wherein displaying a model selection interface further includes displaying, with respect to each of the models, a variable sensitivity indication corresponding to that model, wherein a variable sensitivity indication corresponding to a model depicts input variables with which that model is both associated with and sensitive to.

Example 14 is a computer-implemented method comprising: storing a plurality of models, each model being associated with an input variable and an output variable and each model operable to estimate possible values for the output variable associated with that model; storing scenario information, wherein storing scenario information includes associating each of a plurality of scenarios with two or more of the plurality of models; displaying scenario selection information on a graphical interface by individually depicting each of the plurality of scenarios, wherein individually depicting a scenario includes depicting the models that are associated with that scenario, and wherein depicting a model includes indicating the input variable and the output variable associated with that model; receiving a scenario selection input indicating a selected one of the plurality of scenarios; receiving a model selection input indicating a selected one of the plurality of models associated with the selected scenario; receiving input variable information; generating possible values of the input variable associated with the selected model using the input variable information; and generating a collection of values of the output variable associated with the selected model using the selected model and the possible input values.

Example 15 is the method of example 14, wherein the input variable information includes a rate, and wherein generating the possible values uses the rate.

Example 16 is the method of examples 14 or 15, wherein each of the models is further operable to perform goal-seeking, wherein goal-seeking includes calculating values for the input variable associated with the selected model, and wherein calculating is based on assumed values of the output variable associated with the selected model.

Example 17 is the method of example 16, further comprising: receiving goal-seeking information indicating assumed values of the output variable associated with the selected model; and performing a goal-seeking calculation based on the selected model and the assumed values of the output variable associated with the selected model, wherein performing the goal-seeking calculation includes determining values of the input variable associated with the selected model.

Example 18 is the method of example 17, wherein the selected model includes a mathematical relationship between the input variable associated with the selected model and the output variable associated with the selected model.

Example 19 is the method of example 18, wherein determining values of the input variable associated with the model includes using the mathematical relationship.

Example 20 is the method of examples 14-19, wherein the scenario information includes, for at least one of the plurality of scenarios, a name, a date, or a description.

Example 21 is the method of examples 14-20 further comprising, for each of the depicted scenarios, storing a name and type of the input variable associated with the scenario.

Example 22 is the method of examples 14-21, further comprising: storing multiple input variable manipulation options; receiving selection information indicating a selection of one of the multiple input variable manipulation options; altering the possible values of the input variable associated with the selected model, wherein altering is performed based on the selected one of the multiple input variable manipulation options; and generating updated possible values of the output variable associated with the selected model, wherein generating updated possible values includes using the selected model and the altered possible values of the input variable.

Example 23 is the method of examples 14-22, further comprising displaying a model selection interface, wherein displaying a model selection interface includes displaying, with respect to each of the models, a quality metric representative of that model's performance when evaluated with holdout data.

Example 24 is the method of example 23, wherein displaying a model selection interface further includes displaying, with respect to each of the models, information about the input variable and output variable with which the model is associated.

Example 25 is the method of example 24, wherein each of the multiple models is associated with multiple input variables.

Example 26 is the method of example 25, wherein displaying a model selection interface further includes displaying, with respect to each of the models, a variable sensitivity indication corresponding to that model, wherein a variable sensitivity indication corresponding to a model depicts input variables with which that model is both associated with and sensitive to.

Example 27 is a computer-program product tangibly embodied in a non-transitory machine-readable storage medium, including instructions configured to cause a data processing apparatus to perform operations including: storing a plurality of models, each model being associated with an input variable and an output variable and each model operable to estimate possible values for the output variable associated with that model; storing scenario information, wherein storing scenario information includes associating each of a plurality of scenarios with two or more of the plurality of models; displaying scenario selection information on a graphical interface by individually depicting each of the plurality of scenarios, wherein individually depicting a scenario includes depicting the models that are associated with that scenario, and wherein depicting a model includes indicating the input variable and the output variable associated with that model; receiving a scenario selection input indicating a selected one of the plurality of scenarios; receiving a model selection input indicating a selected one of the plurality of models associated with the selected scenario; receiving input variable information;

generating possible values of the input variable associated with the selected model using the input variable information; and generating a collection of values of the output variable associated with the selected model using the selected model and the possible input values.

Example 28 is the computer-program product of example 27, wherein the input variable information includes a rate, and wherein generating the possible values uses the rate.

Example 29 is the computer-program product of examples 27 or 28, wherein each of the models is further operable to perform goal-seeking, wherein goal-seeking includes calculating values for the input variable associated with the selected model, and wherein calculating is based on assumed values of the output variable associated with the selected model.

Example 30 is the computer-program product of example 29, wherein the operations further include: receiving goal-seeking information indicating assumed values of the output variable associated with the selected model; and performing a goal-seeking calculation based on the selected model and the assumed values of the output variable associated with the selected model, wherein performing the goal-seeking calculation includes determining values of the input variable associated with the selected model.

Example 31 is the computer-program product of example 30, wherein the selected model includes a mathematical relationship between the input variable associated with the selected model and the output variable associated with the selected model.

Example 32 is the computer-program product of example 31, wherein determining values of the input variable associated with the model includes using the mathematical relationship.

Example 33 is the computer-program product of examples 27-32, wherein the scenario information includes, for at least one of the plurality of scenarios, a name, a date, or a description.

Example 34 is the computer-program product of examples 27-33 wherein the operations further include, for each of the depicted scenarios, storing a name and type of the input variable associated with the scenario.

Example 35 is the computer-program product of examples 27-34, wherein the operations further include: storing multiple input variable manipulation options; receiving selection information indicating a selection of one of the multiple input variable manipulation options; altering the possible values of the input variable associated with the selected model, wherein altering is performed based on the selected one of the multiple input variable manipulation options; and generating updated possible values of the output variable associated with the selected model, wherein generating updated possible values includes using the selected model and the altered possible values of the input variable.

Example 36 is the computer-program product of examples 27-35, wherein the operations further include displaying a model selection interface, wherein displaying a model selection interface includes displaying, with respect to each of the models, a quality metric representative of that model's performance when evaluated with holdout data.

Example 37 is the computer-program product of example 36, wherein displaying a model selection interface further includes displaying, with respect to each of the models, information about the input variable and output variable with which the model is associated.

Example 38 is the computer-program product of example 37, wherein each of the multiple models is associated with multiple input variables.

Example 39 is the computer-program product of example 38, wherein displaying a model selection interface further includes displaying, with respect to each of the models, a variable sensitivity indication corresponding to that model, wherein a variable sensitivity indication corresponding to a model depicts input variables with which that model is both associated with and sensitive to.

What is claimed is:

1. A system, comprising:
one or more data processors; and
a non-transitory computer-readable storage medium containing instructions which, when executed on the one or more data processors, cause the one or more data processors to perform operations including:
storing a plurality of models, each model being associated with an input variable and an output variable and each model operable to estimate possible values for the output variable associated with that model;
storing scenario information, wherein storing scenario information includes associating each of a plurality of scenarios with two or more of the plurality of models;
displaying scenario selection information on a graphical interface by individually depicting each of the plurality of scenarios, wherein individually depicting a scenario includes depicting the models that are associated with that scenario, and wherein depicting a model includes indicating the input variable and the output variable associated with that model;
receiving a scenario selection input indicating a selected one of the plurality of scenarios;
receiving a model selection input indicating a selected one of the plurality of models associated with the selected scenario;
receiving input variable information;
generating possible values of the input variable associated with the selected model using the input variable information; and
generating a collection of values of the output variable associated with the selected model using the selected model and the possible input values.

2. The system of claim 1, wherein the input variable information includes a rate, and wherein generating the possible values uses the rate.

3. The system of claim 1, wherein each of the models is further operable to perform goal-seeking, wherein goal-seeking includes calculating values for the input variable associated with the selected model, and wherein calculating is based on assumed values of the output variable associated with the selected model.

4. The system of claim 3, wherein the operations further include:
receiving goal-seeking information indicating assumed values of the output variable associated with the selected model; and
performing a goal-seeking calculation based on the selected model and the assumed values of the output variable associated with the selected model, wherein performing the goal-seeking calculation includes determining values of the input variable associated with the selected model.

5. The system of claim 4, wherein the selected model includes a mathematical relationship between the input variable associated with the selected model and the output variable associated with the selected model, and wherein determining values of the input variable associated with the model includes using the mathematical relationship.

6. The system of claim 1 wherein the operations further include, for each of the depicted scenarios, storing a name and type of the input variable associated with the scenario.

7. The system of claim 1, wherein the operations further include:
storing multiple input variable manipulation options;
receiving selection information indicating a selection of one of the multiple input variable manipulation options;
altering the possible values of the input variable associated with the selected model, wherein altering is performed based on the selected one of the multiple input variable manipulation options; and
generating updated possible values of the output variable associated with the selected model, wherein generating updated possible values includes using the selected model and the altered possible values of the input variable.

8. The system of claim 1, wherein the operations further include displaying a model selection interface, wherein displaying a model selection interface includes displaying, with respect to each of the models, a quality metric representative of that model's performance when evaluated with holdout data.

9. The system of claim 8, wherein displaying a model selection interface further includes:
displaying, with respect to each of the models, information about the input variable and output variable with which the model is associated.

10. The system of claim 9, wherein each of the multiple models is associated with multiple input variables, and wherein displaying a model selection interface further includes displaying, with respect to each of the models, a variable sensitivity indication corresponding to that model, wherein a variable sensitivity indication corresponding to a model depicts input variables with which that model is both associated with and sensitive to.

11. A computer-implemented method, comprising:
storing a plurality of models, each model being associated with an input variable and an output variable and each model operable to estimate possible values for the output variable associated with that model;
storing scenario information, wherein storing scenario information includes associating each of a plurality of scenarios with two or more of the plurality of models;
displaying scenario selection information on a graphical interface by individually depicting each of the plurality of scenarios, wherein individually depicting a scenario includes depicting the models that are associated with that scenario, and wherein depicting a model includes indicating the input variable and the output variable associated with that model;
receiving a scenario selection input indicating a selected one of the plurality of scenarios;
receiving a model selection input indicating a selected one of the plurality of models associated with the selected scenario;
receiving input variable information;
generating possible values of the input variable associated with the selected model using the input variable information; and
generating a collection of values of the output variable associated with the selected model using the selected model and the possible input values.

12. The method of claim 11, wherein the input variable information includes a rate, and wherein generating the possible values uses the rate.

13. The method of claim 11, wherein each of the models is further operable to perform goal-seeking, wherein goal-seeking includes calculating values for the input variable associated with the selected model, and wherein calculating is based on assumed values of the output variable associated with the selected model.

14. The method of claim 13, further comprising:
receiving goal-seeking information indicating assumed values of the output variable associated with the selected model; and
performing a goal-seeking calculation based on the selected model and the assumed values of the output variable associated with the selected model, wherein performing the goal-seeking calculation includes determining values of the input variable associated with the selected model.

15. The method of claim 14, wherein the selected model includes a mathematical relationship between the input variable associated with the selected model and the output variable associated with the selected model, and wherein determining values of the input variable associated with the model includes using the mathematical relationship.

16. The method of claim 11 further comprising, for each of the depicted scenarios, storing a name and type of the input variable associated with the scenario.

17. The method of claim 11, further comprising:
storing multiple input variable manipulation options;
receiving selection information indicating a selection of one of the multiple input variable manipulation options;
altering the possible values of the input variable associated with the selected model, wherein altering is performed based on the selected one of the multiple input variable manipulation options; and
generating updated possible values of the output variable associated with the selected model, wherein generating updated possible values includes using the selected model and the altered possible values of the input variable.

18. The method of claim 11, further comprising displaying a model selection interface, wherein displaying a model selection interface includes displaying, with respect to each of the models, a quality metric representative of that model's performance when evaluated with holdout data.

19. The method of claim 18, wherein displaying a model selection interface further includes:
displaying, with respect to each of the models, information about the input variable and output variable with which the model is associated.

20. The method of claim 19, wherein each of the multiple models is associated with multiple input variables, and wherein displaying a model selection interface further includes displaying, with respect to each of the models, a variable sensitivity indication corresponding to that model, wherein a variable sensitivity indication corresponding to a model depicts input variables with which that model is both associated with and sensitive to.

21. A computer-program product tangibly embodied in a non-transitory machine-readable storage medium, including instructions configured to cause a data processing apparatus to perform operations including:
storing a plurality of models, each model being associated with an input variable and an output variable and each model operable to estimate possible values for the output variable associated with that model;
storing scenario information, wherein storing scenario information includes associating each of a plurality of scenarios with two or more of the plurality of models;
displaying scenario selection information on a graphical interface by individually depicting each of the plurality of scenarios, wherein individually depicting a scenario includes depicting the models that are associated with that scenario, and wherein depicting a model includes indicating the input variable and the output variable associated with that model;
receiving a scenario selection input indicating a selected one of the plurality of scenarios;
receiving a model selection input indicating a selected one of the plurality of models associated with the selected scenario;
receiving input variable information;
generating possible values of the input variable associated with the selected model using the input variable information; and
generating a collection of values of the output variable associated with the selected model using the selected model and the possible input values.

22. The computer-program product of claim 21, wherein the input variable information includes a rate, and wherein generating the possible values uses the rate.

23. The computer-program product of claim 21, wherein each of the models is further operable to perform goal-seeking, wherein goal-seeking includes calculating values for the input variable associated with the selected model, and wherein calculating is based on assumed values of the output variable associated with the selected model.

24. The computer-program product of claim 23, wherein the operations further include:
receiving goal-seeking information indicating assumed values of the output variable associated with the selected model; and
performing a goal-seeking calculation based on the selected model and the assumed values of the output variable associated with the selected model, wherein performing the goal-seeking calculation includes determining values of the input variable associated with the selected model.

25. The computer-program product of claim 24, wherein the selected model includes a mathematical relationship between the input variable associated with the selected model and the output variable associated with the selected model, wherein determining values of the input variable associated with the model includes using the mathematical relationship.

26. The computer-program product of claim 21 wherein the operations further include, for each of the depicted scenarios, storing a name and type of the input variable associated with the scenario.

27. The computer-program product of claim 21, wherein the operations further include:
storing multiple input variable manipulation options;
receiving selection information indicating a selection of one of the multiple input variable manipulation options;
altering the possible values of the input variable associated with the selected model, wherein altering is performed based on the selected one of the multiple input variable manipulation options; and
generating updated possible values of the output variable associated with the selected model, wherein generating updated possible values includes using the selected model and the altered possible values of the input variable.

28. The computer-program product of claim 21, wherein the operations further include displaying a model selection interface, wherein displaying a model selection interface includes displaying, with respect to each of the models, a quality metric representative of that model's performance when evaluated with holdout data.

29. The computer-program product of claim 28, wherein displaying a model selection interface further includes:
displaying, with respect to each of the models, information about the input variable and output variable with which the model is associated.

30. The computer-program product of claim 29, wherein each of the multiple models is associated with multiple input variables, and wherein displaying a model selection interface further includes displaying, with respect to each of the models, a variable sensitivity indication corresponding to that model, wherein a variable sensitivity indication corresponding to a model depicts input variables with which that model is both associated with and sensitive to.
